(19) United States
(12) Patent Application Publication
(10) Pub. No.: US 2025/0220184 A1
(43) Pub. Date: Jul. 3, 2025

(54) ENCODING METHOD, DECODING METHOD, AND BITSTREAM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/083,624

(22) Filed: Mar. 19, 2025

Related U.S. Application Data
(63) Continuation of application No. PCT/CN2022/120361, filed on Sep. 21, 2022.

(51) Int. Cl. H04N 19/124; H04N 19/167; H04N 19/172; H04N 19/70; H04N 19/89

(52) U.S. Cl. CPC H04N 19/124; H04N 19/167; H04N 19/172; H04N 19/70; H04N 19/89

(57) ABSTRACT

An encoding method, a decoding method, and a bitstream are provided in embodiments of the present application. The method includes the following. A bitstream is parsed to determine first syntax element information. Variable information is obtained in response to the first syntax element information indicating that a parity hiding technology is enabled for a sequence. Second syntax element information is determined in response to the variable information indicating that a segment satisfying a first preset coding mode exists in a current picture. An absolute value of a quantized coefficient of a current block is determined, in response to determining, based on the second syntax element information, that a hidden quantized coefficient exists in the current block.

### CROSS-REFERENCE TO RELATED APPLICATION(S)

This application is a continuation of International Application No. PCT/CN2022/120361, filed Sep. 21, 2022, the entire disclosure of which is incorporated herein by reference.

### TECHNICAL FIELD

This disclosure relates to the field of video coding technology, in particular to an encoding method, a decoding method, and a bitstream.

### BACKGROUND

With the improvement of requirements of people on display quality of a video, the computer vision related field has attracted more attention. In recent years, the picture processing technology has been successfully applied in all walks of life. For the encoding and decoding process of pictures in the video, at the encoding end, picture data to be encoded will be compressed and encoded by an entropy coding unit after transformation and quantization, and the bitstream generated after entropy coding will be transmitted to the decoding end. The decoder parses the bitstream, and recovers the original input picture data after performing inverse quantization and inverse transformation.

However, for non-zero quantized coefficients obtained after transformation and quantization, these non-zero quantized coefficients may be positive or negative values. In the process of encoding and decoding, it is necessary to encode and decode identification information of signs of non-zero quantized coefficients, which leads to excessive bitrate and poor encoding and decoding performance.

### SUMMARY

In a first aspect, embodiments of the present application provide a decoding method applied to a decoder. The method is performed by a decoder and includes the following. A bitstream is parsed to determine first syntax element information. Variable information is obtained in response to the first syntax element information indicating that a parity hiding technology is enabled for a sequence. Second syntax element information is determined in response to the variable information indicating that a segment satisfying a first preset coding mode exists in a current picture. An absolute value of a quantized coefficient of a current block is determined, in response to determining, based on the second syntax element information, that a hidden quantized coefficient exists in the current block.

In a second aspect, embodiments of the present application provide an encoding method. The method is performed by an encoder and includes the following. First syntax element information is determined. Variable information is obtained in response to the first syntax element information indicating that a parity hiding technology is enabled for a sequence. Second syntax element information is determined in response to the variable information indicating that a segment satisfying a first preset coding mode exists in a current picture. An absolute value of a quantized coefficient of a current block is encoded based on the second syntax element information.

In a third aspect, embodiments of the present application provide a method of transmitting a bitstream. The bitstream is decoded according to the method of the first aspect, or the bitstream is generated according to the method of the second aspect.

### BRIEF DESCRIPTION OF THE DRAWINGS

FIG. 1 is a schematic diagram of a block-based encoding framework.

FIG. 2A is a schematic block diagram of a structure of a system of an encoder provided in embodiments of the present application.

FIG. 2B is a schematic block diagram of a structure of a system of a decoder provided in embodiments of the present application.

FIG. 3 is a schematic flow chart of a decoding method provided in embodiments of the present application.

FIG. 4A is a schematic diagram of an order of Zig-Zag scan provided in embodiments of the present application.

FIG. 4B is a schematic diagram of an order of Diagonal scan provided in embodiments of the present application.

FIG. 4C is a schematic diagram of an order of column scan provided in embodiments of the present application.

FIG. 4D is a schematic diagram of an order of row scan provided in embodiments of the present application.

FIG. 5 is a schematic diagram of an 8×8 transform block in reverse Zig-Zag scan provided in embodiments of the present application.

FIG. 6A is a schematic diagram of five positions of coded levels referenced in Zig-Zag scan/Diagonal scan for BR of qIdx provided in embodiments of the present application.

FIG. 6B is a schematic diagram of five positions of coded levels referenced in column scan for BR of qIdx provided in embodiments of the present application.

FIG. 6C is a schematic diagram of five positions of coded levels referenced in row scan for BR of qIdx provided in embodiments of the present application.

FIG. 7A is a schematic diagram of three positions of coded levels referenced in Zig-Zag scan/Diagonal scan for LR of qIdx provided in embodiments of the present application.

FIG. 7B is a schematic diagram of three positions of coded levels referenced in column scan for LR of qIdx provided in embodiments of the present application.

FIG. 7C is a schematic diagram of three positions of coded levels referenced in row scan for LR of qIdx provided in embodiments of the present application.

FIG. 8 is a schematic flow chart of an encoding method provided in embodiments of the present application.

FIG. 9 is a schematic diagram of a structure of a decoder provided in embodiments of the present application.

FIG. 10 is a schematic diagram of a specific hardware structure of a decoder provided in embodiments of the present application.

FIG. 11 is a schematic diagram of a structure of an encoder provided in embodiments of the present application.

FIG. 12 is a schematic diagram of a specific hardware structure of an encoder provided in embodiments of the present application.

FIG. 13 is a schematic diagram of a structure of a coding system provided in embodiments of the present application.

### DETAILED DESCRIPTION

To provide a more detailed understanding of features and technical contents of embodiments of the present application, the implementation of embodiments of the present application will be described in detail below with reference to accompanying drawings. The accompanying drawings are merely for reference and illustration but are not intended to limit the embodiments of the present application.

Unless otherwise defined, all technical and scientific terms used herein have the same meanings as commonly understood by those skilled in the art of the present application. The terminology used in the present application is merely for the purpose of describing embodiments of the present application and is not intended to limit the present application.

In the following description, reference is made to “some embodiments”, which describes a subset of all possible embodiments, but it is understood that “some embodiments” may be the same subset or different subsets of all possible embodiments, and may be combined with each other without conflict. It should also be pointed out that the terms “first/second/third” referred to in the embodiments of the present application are merely used to distinguish similar objects, and do not represent a specific ordering for the objects. It is understood that “first/second/third” can be interchanged in terms of a specific order or a priority order where allowed, so that the embodiments of the present application described herein can be implemented in an order other than that illustrated or described herein.

Before further describing the embodiments of the present application in detail, the nouns and terms related to the embodiments of the present application will be described first, and the nouns and terms related to the embodiments of the present application are applicable to the following explanations.
A new generation video coding standard H.266/Versatile Video Coding (VVC)
Coding unit (CU)
Coding tree unit (CTU)
Largest coding unit (LCU)
Prediction unit (PU)
Transform unit (TU)
Transform block (TB)
Discrete cosine transform (DCT)
Alliance for open media (AOM)
AOM video model (AVM)
Rate-distortion optimization quantization (RDOQ)
Sign data hiding (SDH)

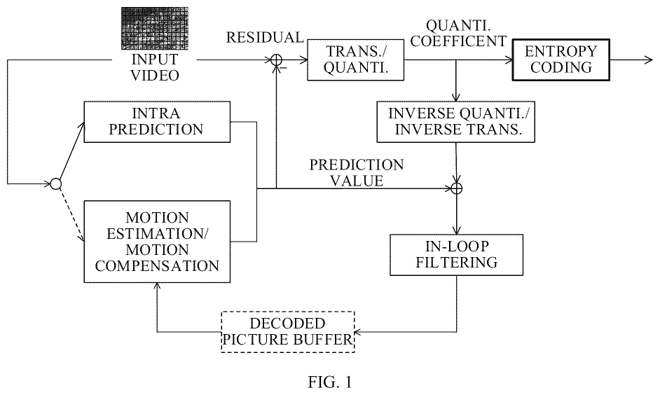

It can be understood that, currently, block-based hybrid encoding frameworks are generally used in universal video coding standards, for example, H.266/versatile video coding (VVC). Each picture of a video is partitioned into largest coding units (LCUs), which are squares of equal size (e.g., 128×128, 64×64, etc.). Each LCU may be partitioned into rectangular coding units (CUs) according to certain rules. The CU may be further partitioned into smaller prediction units (PUs) and transform units (TUs), etc. As illustrated in FIG. 1, the hybrid encoding framework may perform steps such as prediction, transformation, quantization, entropy coding, and in-loop filtering. The prediction may include intra prediction and inter prediction, and the inter prediction may include motion estimation and motion compensation. Since there is strong correlation among neighbouring samples in a picture of the video, using intra prediction in video coding can eliminate spatial redundancy between neighbouring samples. Moreover, since there is also strong similarity between neighbouring pictures in the video, using inter prediction in video coding can eliminate temporal redundancy between neighbouring pictures. Thus, coding efficiency can be improved.

The basic process of video coding is as follows. At an encoder, a picture is partitioned into blocks, and a prediction block of a current block is generated using intra prediction or inter prediction. An original block of the current block is subtracted from the prediction block to obtain a residual block, which is then subjected to transformation and quantization to generate a quantized coefficient matrix, and the quantized coefficient matrix is entropy-coded and signalled into a bitstream. At a decoder, the prediction block of the current block is generated using intra prediction or inter prediction, and at the same time, the quantized coefficient matrix is parsed out from the bitstream. The quantized coefficient matrix is inverse-quantized and inverse-transformed to obtain the residual block, which is added to the prediction block to obtain a reconstructed block. Reconstructed blocks form a reconstructed picture, which is loop-filtered based on the picture or blocks to obtain a decoded picture. The encoder also requires similar operations to obtain the decoded picture. The decoded picture may be used as a reference picture in inter prediction for subsequent pictures. The block partition information and mode information or parameter information (such as for prediction, transformation, quantization, entropy coding, and in-loop filtering) determined at the encoder, may need to be output to the bitstream if necessary. The decoder determines the same block partition information and mode information or parameter information such as for prediction, transformation, quantization, entropy coding, and in-loop filtering as the encoder through parsing and analysis based on available information, ensuring that the decoded picture obtained by the encoder is the same as that obtained by the decoder. The decoded picture obtained by the encoder is typically called the reconstructed picture. During prediction, the current block may be partitioned into PUs, and during transformation, the current block may be partitioned into TUs. The partition for PUs and TUs may be different. The above is the basic process performed by the video codec under the block-based hybrid encoding framework. With the development of technologies, some modules or steps in this framework or process may be optimized. The embodiments of the disclosure are applicable to the basic process under the block-based hybrid encoding framework, but is not limited to this framework or process.

In embodiments of the present application, the current block may be the current CU, the current PU, or the current TU or TB, etc.

It can also be understood that the reference software of AOM is based on the AV1 standard, exploring the encoding tools for the possible standardized AV2. Similar to most mainstream video coding standards, the AOM video model (i.e., AVM) is also a traditional block-based coding, which includes multiple parts, such as block partition, intra prediction, inter prediction, transformation, quantization, entropy coding, in-loop and post-processing filtering, unique coding of screen content, etc. The embodiment of the present application does not limit the traditional coding framework used. In embodiment of the present application, improvements mainly focus on the transformation/quantization and the inverse quantization/inverse transformation, to improve the coding performance of the AVM.

Quantization and inverse quantization are closely related to coefficient encoding. The purpose of quantization is to reduce the dynamic range of transform coefficients, so that the number of bits consumed in encoding coefficients can be reduced. In one possible implementation, the process of quantization and inverse quantization is as follows.

$${q}_{i} = round ( \frac{{t}_{i}}{qstep} ) \qquad ( 1 )$$

$${t}_{i}^{′} = {q}_{i} \cdot qstep \qquad ( 2 )$$

where tᵢ is the transform coefficient, qstep is the quantization step size (which is related to the quantization parameter set in the profile), qᵢ is the quantized coefficient, round( ) is the rounding process, which is not limited to rounding up (ceiling) or rounding down (floor), etc., and the quantization process is controlled by the encoder. tᵢ′ is the reconstructed transform coefficient, and due to the loss of accuracy caused in the rounding process, tᵢ′ is different from tᵢ.

It should be noted that the quantization reduces the accuracy of the transform coefficients, and the loss of accuracy is irreversible. The encoder typically measures the cost of quantization through a rate-distortion cost function. The rate-distortion cost function is as follows.

$$J = D + λ \cdot R = {( {t}_{i} - {t}_{i}^{′} )}^{2} + λ \cdot B ( {q}_{i} ) \qquad ( 3 )$$

where B(qᵢ) is bits consumed in a calculation process of estimating and encoding qᵢ by the encoder, J is the rate-distortion cost, Δ is a preset coefficient, and D is a loss value in the encoding process.

In embodiments of the present application, no matter how the encoder decides the value of qᵢ, the inverse quantization process at the decoding end will not change, so the encoder can decide qᵢ more freely. Generally, the encoder will optimize each qᵢ according to the principle of minimizing the overall cost of the current block. Such a process is called rate-distortion optimization quantization, which is also widely used in video encoding.

In one possible embodiment, for coefficient encoding in AVM, the quantized coefficients can be encoded or decoded with a multi-symbol arithmetic coding method, and each quantized coefficient can be identified by one or more multi-symbol identification. Specifically, according to the magnitude of the quantized coefficient, the quantized coefficient can be represented by the following several multi-symbol identification in segments.

Identification 1 represents a part of 0 to 3, with a total of 4 symbols (0, 1, 2, 3). When the symbol of identification 1 is 3, identification 2 needs to be further encoded/decoded.

Identification 2 represents a part of 3 to 6, with a total of 4 symbols (0, 1, 2, 3). When the symbol of identification 2 is 3, identification 3 needs to be further encoded/decoded.

Identification 3 represents a part of 6 to 9, with a total of 4 symbols (0, 1, 2, 3). When the symbol of identification 3 is 3, identification 4 needs to be further encoded/decoded.

Identification 4 represents a part of 9 to 12, with a total of 4 symbols (0, 1, 2, 3). When the symbol of identification 4 is 3, identification 5 needs to be further encoded/decoded.

Identification 5 represents a part of 12 to 15, with a total of 4 symbols (0, 1, 2, 3). When the symbol of identification 5 is 3, the part greater than or equal to 15 needs to be further encoded/decoded.

It should be noted that, in embodiments of the present application, the part greater than or equal to 15 is encoded/decoded by using a bypass model, such as exponential-Golomb, while for identification 1 to 5, the context model is used, where identification 1 has a separate set of context models and identification 2 to 5 share a set of context models. In addition, if the current coefficient is a non-zero coefficient, it is necessary to encode/decode the sign. The encoding/decoding process of various identification in the current block can include two loop processes as follows.
Loop 1: first, identification 1 to 5 are encoded/decoded according to the scan order from the last non-zero coefficient to the upper left corner of the current block.

In embodiments of the present application, coefficient(s) identified by identification 1 is also referred to as Base Range (BR), coefficients identified by identification 2 to 5 are referred to as Lower Range (LR), and the part of the value(s) greater than 15 is referred to as the Higher Range (HR). The absolute value of the sum of identification 1-5 of the quantized-coefficient index qIdx obtained by decoding can also be written as the following formula (4).

$$qIdx = \sum ( Br + \sum LR ) \qquad ( 4 )$$

Since the LR includes four identification 2-5, ΣLR herein is used to identify summation of identification 2-5.

When the parity hiding technology is not introduced, the absolute value level of the quantized coefficient is equal to qIdx (i.e., level=qIdx).
Loop 2: then, according to the scan order from the upper left corner of the current block to the last non-zero coefficient, the sign(s) of the non-zero coefficient(s) and the part exceeding 15 are encoded/decoded, respectively, where if the coefficient at the upper left corner is a non-zero coefficient, the sign of this coefficient is encoded/decoded using the context model, and the non-zero coefficient(s) at the remaining position(s) is encoded/decoded using the bypass model (also be referred to as an “equal probability model”).

In the implementation, codes of coefficient encoding in AVM is illustrated in Table 1.

TABLE 1

| | |
|---|---|
| for(c=eob-1;c>=0;c--){ | |
| pos=scan[c] | |
| if(c==(eob-1)){ | |
| coeff_base_eob | S( ) |
| level=coeff_base_eob+1 | |
| }else{ | |
| coeff_base | S( ) |
| level=coeff_base | |
| } | |
| if(level>NUM_BASE_LEVELS){ | |
| for(idx=0; | |
| idx<COEFF_BASE_RANGE/(BR_CDF_SIZE-1); | |
| idx++){ | |
| coeff_br | S( ) |
| level+=coeff_br | |
| if(coeff_br<(BR_CDF_SIZE-1)) | |
| break | |
| } | |
| } | |
| Quant[pos]=level | |
| } | |
| for(c=0;c<eob;c++){ | |
| pos=scan[c] | |
| if(Quant[pos]!=0){ | |
| if(c==0){ | |
| dc_sign | S( ) |
| sign=dc_sign | |
| }else{ | |
| sign_bit | L(1) |
| sign=sign_bit | |
| } | |
| }else{ | |
| sign=0 | |
| } | |
| if(Quant[pos]> | |
| (NUM_BASE_LEVELS+COEFF_BASE_RANGE)){ | |
| length=0 | |
| do{ | |
| length++ | |
| golomb_length_bit | L(1) |
| }while(!golomb_length_bit) | |
| x=1 | |
| for(i=length-2;i>=0;i--){ | |
| golomb_data_bit | L(1) |
| x=(x<<1)\|golomb_data_bit | |
| } | |
| Quant[pos]=x+COEFF_BASE_RANGE+NUM_BASE_LEVELS | |
| } | |
| if(pos==0&&Quant[pos]>0){ | |
| dcCategory=sign?1:27 | |
| } | |
| Quant[pos]=Quant[pos]&0xFFFFF | |
| culLevel+=Quant[pos] | |
| if(sign) | |
| Quant[pos]=-Quant[pos] | |
| } | |

In Table 1, S( ) is multiple-symbol context model encoding/decoding, and L(1) is bypass model encoding/decoding.

In the related art, in a reference implementation of AOM, each picture may include multiple segments, up to eight, which may independently use lossless compression (lossless coding) or lossy compression (encoding). For the non-zero quantized coefficients subjected to transform and quantization corresponding to one transform block in the segment, whether the parity hiding technology is applied to the transform block can be determine based on the number of the non-zero quantized coefficients. In the parity hiding technology, the change of adjusted value of the quantized coefficient cannot be used in lossless compression, and such a change of the value of the quantized coefficient cannot be used in lossless compression and near-lossless coding, resulting in the low applicability of the parity hiding technology, so the parity hiding technology should be turned off for lossless coded segments.

Based on this, embodiments of the present application provide a decoding method. A bitstream is parsed to determine first syntax element information. Variable information is obtained when the first syntax element information indicates that a parity hiding technology is enabled for a sequence. Second syntax element information is determined when the variable information indicates that a segment satisfying a first preset coding mode exists in a current picture. An absolute value(s) of a quantized coefficient(s) of a current block is determined, when it is determined, based on the second syntax element information, that a hidden quantized coefficient exists in the current block.

Embodiments of the present application provide an encoding method. First syntax element information is determined. Variable information is obtained when the first syntax element information indicates that a parity hiding technology is enabled for a sequence. Second syntax element information is determined when the variable information indicates that a segment satisfying a first preset coding mode exists in a current picture. An absolute value of a quantized coefficient of a current block is encoded based on the second syntax element information.

In this way, at the encoding end or the decoding end, when it is determined according to the first syntax element information that the parity hiding technology is enabled at sequence-level, whether to determine the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the codec encodes the absolute value of the quantized coefficient of the current block with the parity hiding technology. Thus, according to the high-level syntax (i.e., the second syntax element information) that depends on whether lossy coding (or conversely understood as lossless coding) is adopted, the encoding and decoding process using the parity hiding technology can be controlled effectively. Therefore, in the process of encoding and decoding, the applicability of using the parity hiding technology can be improved, and with the better applicability of the parity hiding technology, the parity hiding technology is applied to the process of encoding and decoding, to reduce the bitrate of encoding and decoding and improve the efficiency and performance of encoding and decoding.

The embodiments of the present application will be described in detail below with reference to the accompanying drawings.

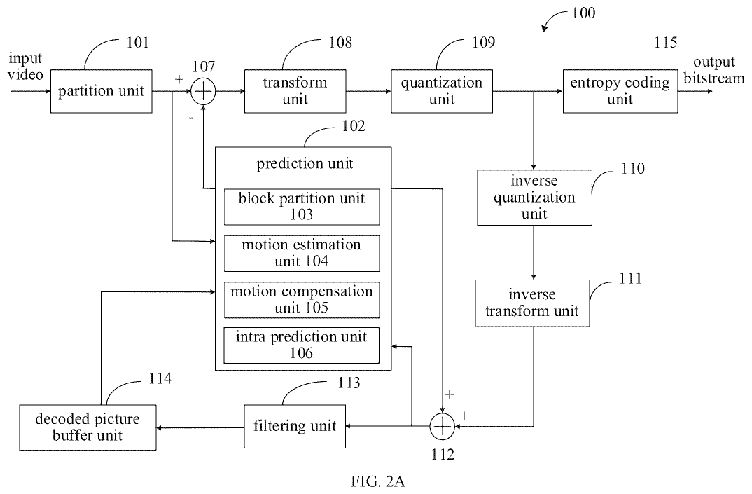

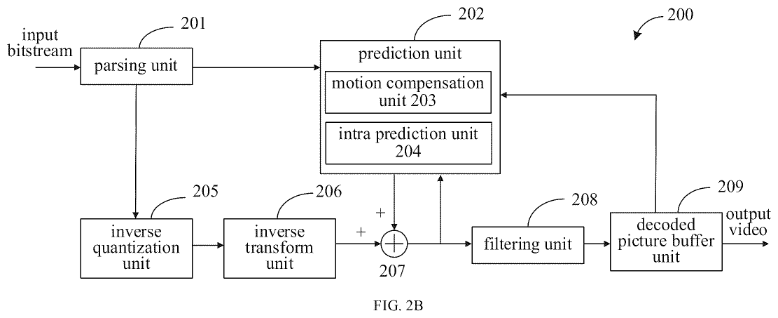

Referring to FIG. 2A, it illustrates a schematic block diagram of a structure of a system of an encoder provided in embodiments of the present application. As illustrated in FIG. 2A, the encoder 100 includes a partition unit 101, a prediction unit 102, a first adder 107, a transform unit 108, a quantization unit 109, an inverse quantization unit 110, an inverse transform unit 111, a second adder 112, a filtering unit 113, a decoded picture buffer (DPB) unit 114, and an entropy coding unit 115. Herein, the input of the encoder 100 may be a video consisting of a serial of pictures or a still picture, and the output of the encoder 100 may be a bitstream (also called code stream) representing a compressed version of an input video.

The partition unit 101 partitions a picture in the input video into one or more coding tree units (CTUs). The partition unit 101 partitions the picture into multiple tiles, and may further partition a tile into one or more bricks. Herein, a tile or a brick may contain one or more integral and/or partial CTUs. In addition, the partition unit 101 may form one or more slices, where a slice may contain one or more tiles in a raster order in the picture, or one or more tiles covering a rectangular region in the picture. The partition unit 101 may also form one or more sub-pictures, each of which can contain one or more slices, tiles, or bricks.

In the encoding process of the encoder 100, the partition unit 101 passes CTUs to the prediction unit 102. Generally, the prediction unit 202 can include a block partition unit 103, a motion estimation (ME) unit 104, a motion compensation (MC) unit 105, and an intra prediction unit 106. Specifically, the block partition unit 103 further partitions the input CTU into smaller coding units (CUs) using quadtree partition, binary partition, and ternary partition, iteratively. The prediction unit 102 may use the ME unit 104 and the MC unit 105 to obtain an inter prediction block of a CU. The intra prediction unit 106 may obtain an intra prediction block of a CU using various intra prediction modes. In an example, a rate-distortion optimized motion estimation method may be invoked by the ME unit 104 and the MC unit 105 to obtain the inter prediction block, and a rate-distortion optimized mode determination method may be invoked by the intra prediction unit 106 to obtain the intra prediction block.

In embodiments of the present application, the prediction unit 102 outputs the prediction block of the CU, and the first adder 107 calculates the difference between the CU in the output of the partition unit 101 and the prediction block of the CU, that is, the residual CU. The transform unit 108 reads the residual CU and performs one or more transform operations on the residual CU to obtain coefficients. The quantization unit 109 quantizes the coefficients and outputs quantized coefficients (i.e., levels). The inverse quantization unit 110 performs a scaling operation on the quantized coefficients to output reconstructed coefficients. The inverse transform unit 111 performs one or more inverse transforms corresponding to the transforms in the transform unit 108 and outputs a reconstructed residual. The second adder 112 calculates the reconstructed CU by adding the reconstructed residual and the prediction block of the CU from the prediction unit 102. The second adder 112 also sends its output to the prediction unit 102 for use as a reference for intra prediction. After all CUs in the picture or sub-picture have been reconstructed, the filtering unit 113 performs in-loop filtering on the reconstructed picture or sub-picture. Herein, the filtering unit 113 contains one or more filters, such as a deblocking filter, a sample adaptive offset (SAO) filter, and a neural network based filter, etc. Alternatively, when the filtering unit 113 determines that the CU is not used as a reference for encoding other CUs, the filtering unit 113 performs in-loop filtering on one or more target samples in the CU.

The output of the filtering unit 113 is a decoded picture or sub-picture, which is buffered to the DPB unit 114. The DPB unit 114 outputs decoded pictures or sub-pictures according to timing and control information. Herein, the pictures stored in the DPB unit 114 may also be used as a reference for performing inter prediction or intra prediction by the prediction unit 102. Finally, the entropy coding unit 115 converts the parameters (such as control parameters and supplemental information, etc.) from the encoder 100 that are necessary for the decoded picture into binary form, and writes such binary form into the bitstream according to the syntax structure of each data unit, that is, the encoder 100 finally outputs the bitstream

Furthermore, the encoder 100 may have a second processor and a second memory recording a computer program. When the second processor reads and runs the computer program, the encoder 100 reads the input video and generates a corresponding bitstream. In addition, the encoder 100 may also be a computing device having one or more chips. These units, implemented as integrated circuits on a chip, have similar connection and data exchange functions as the corresponding units in FIG. 2A.

Referring to FIG. 2B, it illustrates a schematic block diagram of a structure of a system of a decoder provided in embodiments of the present application. As illustrated in FIG. 2B, the decoder 200 may include: a parsing unit 201, a prediction unit 202, an inverse quantization unit 205, an inverse transform unit 206, an adder 207, a filtering unit 208, and a decoded picture buffer unit 209. Herein, the input of the decoder 200 is a bitstream for representing a compressed version of a video or a still picture, and the output of the decoder 200 may be a decoded video consisting of a serial of pictures or a decoded still picture.

The input bitstream of the decoder 200 may be the bitstream generated by the encoder 100. The parsing unit 201 parses the input bitstream and obtains values of syntax elements from the input bitstream. The parsing unit 201 converts the binary representations of the syntax elements into numerical values and sends the numerical values to the units in decoder 200 to obtain one or more decoded pictures. The parsing unit 201 may also parse one or more syntax elements from the input bitstream to display decoded pictures.

In the decoding process of the decoder 200, the parsing unit 201 sends the values of the syntax elements as well as one or more variables, set or determined according to the values of the syntax elements, for obtaining one or more decoded pictures to the units in the decoder 200.

The prediction unit 202 determines a prediction block of a current decoding block (e.g., CU). Herein, the prediction unit 202 may include a motion compensation unit 203 and an intra prediction unit 204. Specifically, when it is indicated that the inter decoding mode is used for decoding the current decoding block, the prediction unit 202 passes relevant parameters from the parsing unit 201 to the motion compensation unit 203 to obtain the inter prediction block; when it is indicated that the intra prediction mode is used for decoding the current decoding block, the prediction unit 202 transmits the relevant parameters from the parsing unit 201 to the intra prediction unit 204 to obtain the intra prediction block.

The inverse quantization unit 205 has the same function as the inverse quantization unit 110 in the encoder 100. The inverse quantization unit 205 performs scaling operations on the quantized coefficients (i.e., levels) from the parsing unit 201 to obtain reconstructed coefficients.

The inverse transform unit 206 has the same function as the inverse transform unit 111 in the encoder 100. The inverse transform unit 206 performs one or more transform operations (i.e., inverse operations of the one or more transform operations performed by the inverse transform unit 111 in encoder 100) to obtain a reconstructed residual.

The adder 207 performs an addition operation on its inputs (the prediction block from the prediction unit 202 and the reconstructed residual from the inverse transform unit 206) to obtain the reconstructed block of the current decoding block. The reconstructed block is also sent to the prediction unit 202 to be used as a reference for other blocks encoded in the intra prediction mode.

After all CUs in the picture or sub-picture have been reconstructed, the filtering unit 208 performs in-loop filtering on the reconstructed picture or sub-picture. The filtering unit 208 contains one or more filters, such as a deblocking filter, a sample adaptive offset filter, a neural network based filter, and the like. Alternatively, when the filtering unit 208 determines that the reconstructed block is not to be used as a reference for decoding other blocks, the filtering unit 208 performs in-loop filtering on one or more target samples in the reconstructed block. Herein, the output of the filtering unit 208 is a decoded picture or sub-picture, and the decoded picture or sub-picture is buffered in the DPB unit 209. The DPB unit 209 outputs the decoded picture or sub-picture according to timing and control information. The pictures stored in the DPB unit 209 may also be used as a reference for performing inter prediction or intra prediction by the prediction unit 202.

Furthermore, the decoder 200 may have a first processor and a first memory recording a computer program. When the first processor reads and runs the computer program, the decoder 200 reads the input bitstream and generates a corresponding decoded video. Additionally, the decoder 200 may also be a computing device having one or more chips. These units, implemented as integrated circuits on a chip, have similar connection and data exchange functions as the corresponding units in FIG. 2B.

It should also be noted that, in the case that the embodiments of the present application are applied to the encoder 100, the “current block” specifically refers to a block currently to be encoded. In the case that the embodiments of the present application are applied to the decoder 200, the “current block” specifically refers to a block currently to be decoded.

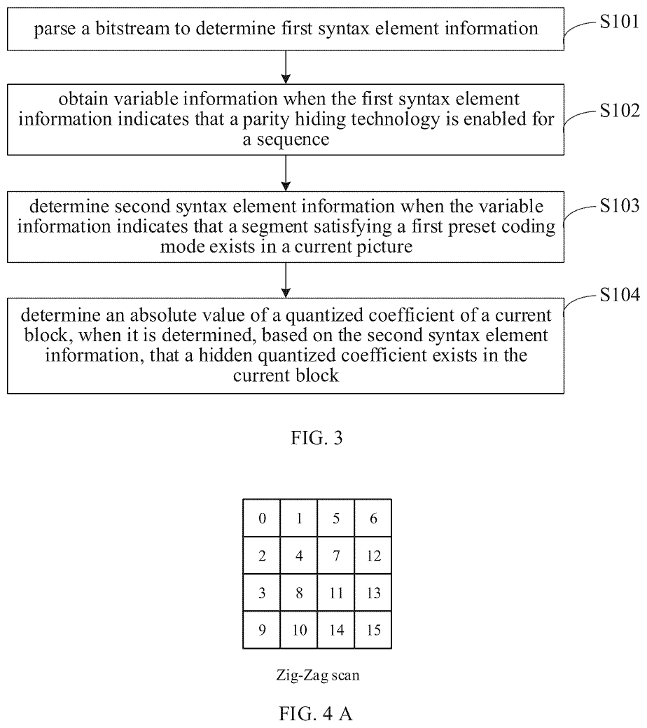

In one embodiment of the present application, FIG. 3 illustrates a schematic flow chart of a decoding method provided in embodiments of the present application. As illustrated in FIG. 3, the method includes the following.
S101, a bitstream is parsed to determine first syntax element information.
S102, variable information is obtained when the first syntax element information indicates that a parity hiding technology is enabled for a sequence.

The decoding method provided in embodiments of the present application is applied to a decoder, particularly to a decoder in the AVM. In addition, the decoding method may be related to the design of syntax elements. For the use of the parity hiding technology for the current block, depending on whether lossy coding or lossless coding is used, the high-level syntax is designed, and the parity-hiding-technology flag is determined. Therefore, in the process of encoding and decoding, the applicability of using the parity hiding technology can be improved, and with the better applicability of the parity hiding technology, the parity hiding technology is applied to the process of encoding and decoding, to reduce the bitrate of encoding and decoding and improve the efficiency and performance of encoding and decoding.

In embodiments of the present application, for encoding and decoding of a sequence of a video, the sequence of the video may include multiple pictures, each picture may include multiple segments, and each segment may include multiple blocks. In the present application, the encoding and decoding process is described in a unit of block.

In embodiments of the present application, for the bitstream transmitted to the decoder by the encoder, the decoder sequentially decodes the bitstream in the order of parsing out sequence-level information, picture-level (or frame-level) information, segment-level information, block-level information, etc.

It should be noted that, in encoding, the encoder may encode the current block by using the parity hiding technology, to reduce the encoding bitrate and improve the encoding performance. Correspondingly, in decoding, the decoder also needs to decode in different decoding methods according to whether the parity hiding technology is applied to the current block. Therefore, for the parity hiding technology, when the decoder parses the bitstream, the decoder will first parse the sequence-level information, such as first syntax element information, by parsing a set of a series of sequence header information.

The first syntax element information represents a sequence-level flag. In embodiments of the present application, in a scenario where the parity hiding technology is used, the first syntax element information may exemplarily be a sequence-level parity-hiding-technology flag. The first syntax element information represents, for the current sequence of the video, whether the parity hiding technology is enabled for the sequence.

In embodiments of the present application, the first syntax element information may be a first value or a second value. If a value of the first syntax element information is the first value, it is determined that the first syntax element information (i.e., the sequence-level parity-hiding-technology flag) indicates that the parity hiding technology is enabled for the current sequence of the video to be processed. If the value of the first syntax element information is the second value, it is determined that the first syntax element information indicates that the parity hiding technology is disabled for the current sequence of the video to be processed.

In embodiments of the present application, the first value and the second value are different, and the first value and the second value may be in the form of parameters or numbers. Specifically, the first syntax element information may be a parameter written in a profile or a value of a flag, which is not specifically limited herein.

Exemplarily, taking flag as an example, the flag is set in two ways: an enable flag (enable_flag) and a disable flag (disable_flag). If a value of the enable flag is the first value and a value of the disable flag is the second value, then, for the first value and the second value, the first value may be set to 1 and the second value may be set to 0, or the first value may be set to true and the second value may be set to false. However, embodiments of the present application are not specifically limited.

Exemplarily, the first syntax element information may be represented as enable_ph. enable_ph is used to represent the sequence-level parity-hiding-technology flag.

In some embodiments of the present application, when the first syntax element information represents that the parity hiding technology is enabled, the decoder determines whether to further parse subordinate syntax element information (subordinate parity-hiding-technology flag, that is, the second syntax element information) by obtaining the variable information.

It is noted that the variable information may include picture-level variable information and segment-level variable information. The variable information represents whether lossy coding (i.e., the first preset coding mode) is applied, where the picture-level variable information represents whether the lossy coding mode is applied to the current picture, and the segment-level variable information represents whether the lossy coding mode is applied to the current segment.

In embodiments of the present application, the variable information can be directly obtained by other information in the decoding process, and the embodiment of the present application is not limited.
S103, second syntax element information is determined when the variable information indicates that a segment satisfying a first preset coding mode exists in a current picture.

In embodiments of the present application, after the decoder obtains the variable information, since the coding mode of the segment in the current picture can be determined according to the variable information, the decoder parses the second syntax element information when the variable information indicates that there is a segment satisfying the first preset coding mode in the current picture.

In embodiments of the present application, the first preset coding mode may be a lossy coding mode, and the second preset coding mode may be a lossless coding mode or a near-lossless coding mode.

It should be noted that the decoder may control whether it is necessary to parse the second syntax element information by depending on whether there is a segment adopting the lossy coding mode in the current picture, to determine, according to the second syntax element information, whether it is necessary to adopt the parity hiding technology when decoding the current block.

In some embodiments of the present application, the second syntax element information represents a picture-level flag or a segment-level flag.

In embodiments of the present application, in a scenario where the parity hiding technology is used, the second syntax element information represents whether the parity hiding technology is enabled for the segment in the current picture. The second syntax element information may exemplarily be a picture-level parity-hiding-technology flag or a segment-level parity-hiding-technology flag. The picture-level parity-hiding-technology flag represents whether the parity hiding technology is enabled for the current picture, and the segment-level parity-hiding-technology flag represents whether the parity hiding technology is enabled for the current segment.

In embodiments of the present application, the second syntax element information may be a first value or a second value. If the value of the second syntax element information is the first value, it is determined that the second syntax element information indicates that the parity hiding technology is enabled for the current picture or current segment to be processed. If the value of the second syntax element information is a second value, it is determined that the second syntax element information indicates that the parity hiding technology is not enabled for the current picture or current segment to be processed.

In embodiments of the present application, the first value and the second value are different, and the first value and the second value may be in the form of parameters or numbers. The second syntax element information may be a parameter written in a profile or a value of a flag, which is not specifically limited herein.

Exemplarily, taking flag as an example, the flag is set in two ways: an enable flag (enable_flag) and a disable flag (disable_flag). If a value of the enable flag is the first value and a value of the disable flag is the second value, then, for the first value and the second value, the first value may be set to 1 and the second value may be set to 0, or the first value may be set to true and the second value may be set to false. However, embodiments of the present application are not specifically limited.

For example, when the second syntax element information is a picture-level parity-hiding-technology flag, it may be expressed as allow_ph; when the second syntax element information is a segment-level parity-hiding-technology flag, it may be expressed as allow_ph_seg.

In some embodiments of the present application, when the variable information indicates that there is no segment satisfying the first preset coding mode in the current picture, which indicates that the parity hiding technology is not used for the current block, the current block is decoded to determine the absolute value of the quantized coefficient.

It can be understood that the decoder determines or parses the second syntax element information by depending on whether a coding mode adopted by the current picture or the current segment in the current picture that are to be processed is the first preset coding mode, and determines the second syntax element information when the coding mode adopted is the first preset coding mode. This is because, if the coding mode adopted by the current picture or the current segment in the current picture is the second preset coding mode, the parity hiding technology is not adopted, and the second syntax element information is not necessary to be determined. In this case, the decoder can already make it clear that the parity hiding technology is not considered when decoding the current picture or the current segment in the current picture, and there is no need to spend time to parse of the second syntax element information, thereby effectively improving the decoding efficiency and the decoding performance.
S104, an absolute value of a quantized coefficient of a current block is determined, when it is determined, based on the second syntax element information, that a hidden quantized coefficient exists in the current block.

In some embodiments of the present application, when the decoder parses or determines the second syntax element information, whether the parity hiding technology is applied to the current picture or the segment in the current picture can be known. If the parity hiding technology is applied to the current picture or the segment in the current picture, it is sometimes necessary to further determine whether the parity hiding technology is applied to the current block. Therefore, when the decoder determines based on the second syntax element information that there is a hidden quantized coefficient in the current block, the decoder can further decode the current block and determine the absolute value of the quantized coefficient of the current block.

Note that, the decoder determines that a hidden quantized coefficient exists in the current block, which means that the parity hiding technology is used for the current block.

In some embodiments of the present application, the current block may include multiple transform blocks, and each transform block may be partitioned into one or more regions. Taking the current region as an example, when the absolute value of the quantized coefficient of the current block is scanned according to a preset scan order, whether there is a hidden quantized coefficient with hidden identification in the current region is first determined. If it is determined that there is a hidden quantized coefficient in the current region, it is necessary to hide the identification information corresponding to the hidden quantized coefficient, that is, the identification information corresponding to the hidden quantized coefficient is not encoded/decoded. Then, the identification information corresponding to the hidden quantized coefficient is directly determined according to the related characteristics of the absolute value(s) of the non-zero quantized coefficient(s) in the current region. That is, when decoding, the decoder needs to determine the identification information corresponding to the hidden quantized coefficient through the related characteristics of the absolute value of the non-zero quantized coefficient, and then determine the absolute value of the hidden quantized coefficient.

It should be noted that, in embodiments of the present application, the current block may be partitioned into one or more regions, where each region contains the absolute value of at least one quantized coefficient. Each region may present a hidden quantized coefficient with hidden identification, that is, each region may present a hidden quantized coefficient whose identification information does not need to be encoded/decoded.

Note that, in embodiments of the present application, the preset scan order may be Diagonal, Zigzag scan, Diagonal scan, horizontal scan (row scan), vertical scan (column scan), 4×4 sub-block scan, or any other scan order, which is not limited herein.

It can be understood that, in some embodiments, the region partition of the current block may be implemented as follows. In the preset scan order, region partition is performed on the current block according to a preset size value, to determine at least one region, where the current region is a currently decoding region in the at least one region.

Herein, the size of the at least one region may be the same or different.

It should be noted that, in embodiments of the present application, the preset size value is the size preset for each region. Here, the preset size value may be a fixed value, or a variable value or fixed value signalled in the bitstream. In a specific embodiment, the value of the preset size value may be set to 16. In addition, when the preset size value is signalled in the bitstream, it may be encoded in a sequence header, a picture header, or the like, which is not limited herein.

Thus, in the AVM, it is assumed that the current block contains 2^{M} sample values, and each of the partitioned multiple regions contains 2^{N} sample values. 2^{M} divided by 2^{N} is a positive integer. 2^{N} sample values are consecutive 2^{N} coefficients in the preset scan order, where these coefficients may include zero or non-zero coefficients (here referred to as quantized coefficients). In addition, if the current block is partitioned into multiple regions, the sizes of the multiple regions may be the same, that is, each region contains 2^{N} sample values. Alternatively, the sizes of the multiple regions may be different, that is, the current block may be partitioned into multiple regions that are consecutive in a preset scan order but have different numbers of samples.

It can also be understood that, after region partition, for at least one region obtained, the steps of determining whether there is a hidden quantized coefficient with hidden identification and how to determine the identification information corresponding to the hidden quantized coefficient are the same for each region, and the following merely describes the current region as an example.

In some embodiments of the present application, when it is determined, based on the second syntax element information, that a hidden quantized coefficient exists in the current block, the absolute value of the quantized coefficient of the current block is determined as follows. The decoder determines the absolute value of the quantized coefficient of the current block, when it is determined, according to the second syntax element information and at least one of the number of decoded non-zero quantized coefficients, a colour component of the current block, or a transform type of the current block, that a hidden quantized coefficient exists in the current block.

It should be noted that the decoder determines that a hidden quantized coefficient exists in the current block according to the second syntax element information and the number of decoded non-zero quantized coefficients, according to the second syntax element information and the colour component of the current block, according to the second syntax element information and the transform type of the current block, according to the second syntax element information, the number of decoded non-zero quantized coefficients, and the colour component of the current block, according to the second syntax element information, the number of decoded non-zero quantized coefficients, and the transform type of the current block, according to the second syntax element information, the colour component of the current block, and the transform type of the current block, according to the second syntax element information, the number of decoded non-zero quantized coefficients, the colour component of the current block, and the transform type of the current block.

For example, in embodiments of the present application, when the decoder parses that the second syntax element information indicates that the parity hiding technology is used, the decoder scans the absolute values of the decoded quantized coefficients in the current region of the current block according to the preset scan order, to determine the number of the decoded non-zero quantized coefficients in the current region. According to the number of the non-zero quantized coefficients, whether there is a hidden quantized coefficient with hidden identification in the current region is determined.

In embodiments of the present application, if the number of the non-zero quantized coefficients is greater than or equal to a number threshold, it is determined that there is a hidden quantized coefficient in the current region. If the number of the non-zero quantized coefficients is less than the number threshold, it is determined that there is no hidden quantized coefficient in the current region.

In some embodiments of the present application, the determining according to the second syntax element information and at least one of the number of decoded non-zero quantized coefficients, the colour component of the current block, or the transform type of the current block includes the following. Determine that a hidden quantized coefficient exists in the current block when the second syntax element information indicates that the parity hiding technology is enabled and at least one of the following is satisfied: the number of the decoded non-zero quantized coefficients is greater than or equal to the number threshold, the colour component of the current block is a preset component, or the transform type of the current block is a preset transform type. The absolute value of the quantized coefficient of the current block is determined when a hidden quantized coefficient exists in the current block.

Note that, in a case where the second syntax element information indicates that the parity hiding technology is enabled, in combination with at least one of: the number of decoded non-zero quantized coefficients is greater than or equal to the number threshold, the colour component of the current block is the preset component, or the transform type of the current block is the preset transform type, it is determined that a hidden quantized coefficient exists in the current block. Otherwise, it is determined that no hidden quantized coefficient exists in the current block.

In embodiments of the present application, whether the parity hiding technology is applied may be set for different colour components, and the embodiment of the present application is not limited.

The colour component may include at least one of a first colour component, a second colour component, and a third colour component. The first colour component may be a luma colour component, the second colour component and the third colour component each may be a chroma colour component (e.g., the second colour component is a blue chroma colour component, the third colour component is a red chroma colour component; alternatively, the second colour component is a red chroma colour component and the third colour component is a blue chroma colour component).

Exemplarily, in some embodiments of the present application, the preset component may be the first colour component. The number threshold may be 4 but needs to be non-zero, and the embodiments of the present application are not limited. For example, the number of the non-zero quantized coefficients is greater than 3, or the number of the non-zero quantized coefficients is greater than or equal to 4.

In some embodiments of the present application, in AVM, during encoding the quantized coefficients, different coefficient encoding orders (scan orders) are selected according to different selected transform modes. For example, the following 16 transforms may be included, and the embodiments of the present application are not limited. Taking these 16 transforms as an example, a correspondence between the 16 transforms and the scan orders is illustrated in Table 2 below.

TABLE 2

| | Transform | | |
|---|---|---|---|
| | Type | Vertical Mode | Horizontal Mode |
| DCT_DCT | 2D | DCT | DCT |
| ADST_DCT | 2D | ADST | DCT |
| DCT_ADST | 2D | DCT | ADST |
| ADST_ADST | 2D | ADST | ADST |
| FLIPADST_DCT | 2D | Flipped ADST | DCT |
| DCT_FLIPADST | 2D | DCT | Flipped ADST |
| FLIPADST_FLIPADST | 2D | Flipped ADST | Flipped ADST |
| ADST_FLIPADST | 2D | ADST | Flipped ADST |
| FLIPADST_ADST | 2D | Flipped ADST | ADST |
| IDTX | 2D | Identity | Identity |
| V_DCT | 1D | DCT | Identity |
| H_DCT | 1D | Identity | DCT |
| V_ADST | 1D | ADST | Identity |
| H_ADST | 1D | Identity | ADST |
| V_FLIPADST | 1D | Flipped ADST | Identity |
| H_FLIPADST | 1D | Identity | Flipped ADST |

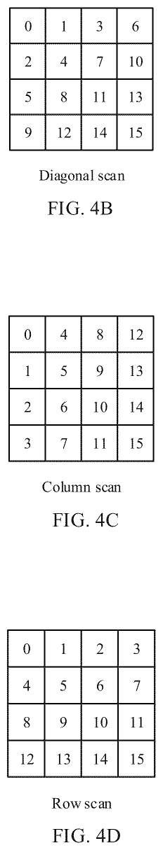

The scan manner of 1D Transform Type includes row scan and column scan according to the horizontal direction and vertical direction. The 2D Transform Type can include Zig-Zag scan and Diagonal scan. The scan order of Zig-Zag scan is illustrated in FIG. 4A, the scan order of Diagonal scan is illustrated in FIG. 4B, the order of column scan is illustrated in FIG. 4C, and the scan order of row scan is illustrated in FIG. 4D. In the forward order, scan from position 0 to position 15 sequentially, and in the reverse order, scan from position 15 to position 0.

It should be noted that each transform block is partitioned into multiple regions and in each region, the parity of one quantized coefficient can be hided. For the hidden quantized coefficient with hidden parity and the quantized coefficient without hidden parity, different groups of context models may be used to decode the quantized coefficient.

Exemplarily, the correspondence between the absolute value level of the quantized coefficient with hidden parity and the decoded qIdx is illustrated in the following formula (5):

$$level = qIdx \times 2 + Parity \qquad ( 5 )$$

where qIdx is the sum of BR, ΣLR, and HR, Parity is the hidden parity value. The absolute value of the quantized coefficient without hidden parity is equal to the decoded qIdx.

For example, the preset transform type may be a non-Identity type in Table 2, and the embodiment of the present application is not limited.

For example, in a case where the number of decoded non-zero quantized coefficients is greater than or equal to the number threshold, the colour component of the current block is the preset component, the transform type of the current block is the preset transform type, and the second syntax element information indicates that the parity hiding technology is enabled, the logic for determining that the hidden quantized coefficient exists in the current block may be expressed as follows.

```
isHidePar = num_nz >= PHTHRESH
  &&condition
  && plane_type == PLANE_TYPE_Y
  && primary_tx_type < IDTX
```

Herein, the number of the decoded non-zero quantized coefficients is expressed as num_nz, PHTHRESH is the number threshold, ‘condition’ may be expressed as the second syntax element information indicating that the parity hiding technology is enabled, the colour component of the current block is expressed as plane_type, the luma colour component is expressed as PLANE_TYPE_Y, the transform type of the current block is expressed as primary_tx_type, and the preset transform type is expressed as <IDTX.

Exemplarily, when the second syntax element information indicates that the parity hiding technology is enabled, the transform block may be partitioned into one region for every 16 positions in the scan order, and for each region, the last position in the scan order is the position where the parity may be hidden. When non-zero quantized coefficients, the number (quantity) of which is greater than or equal to the specified number threshold (e.g., exceeding 3), exists at other positions in this region, the parity of the coefficient at the position where the parity may be hidden will be hidden.

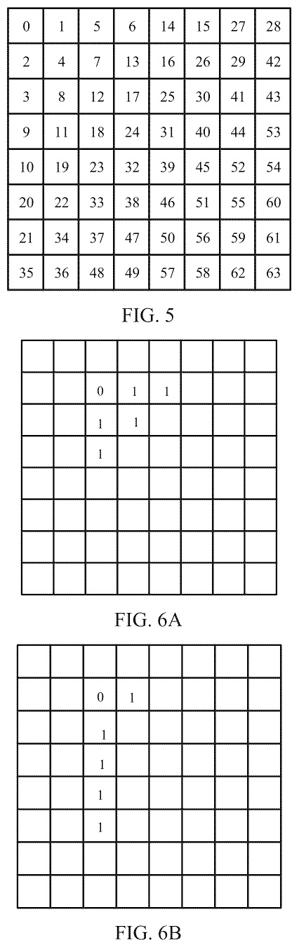

FIG. 5 illustrates a specific example of an 8×8 transform block of a reverse Zig-Zag scan, where the scan order is from 63 to 0. The transform block can be partitioned into four regions, which are indicated by indices 48-63, 32-47, 16-31, 0-15, respectively. The parities of the coefficients at the four positions of indices 48, 32, 16, and 0 may be hidden. Index 21 indicates the last non-zero coefficient in the transform block. In coefficient encoding and decoding, the position whose index is greater than 21 will be skipped and default to zero, and encoding and decoding of context model identification and equal probability identification are performed in the order of 21, 20, . . . , 0. If there are more than three non-zero coefficients from position 21 to position 17, then the parity of sum of BR+ΣLR on each position represents the parity at the 16-th position. If there are more than three non-zero coefficients from position 15 to position 1, then the parity of sum of BR+ΣLR on each position represents the parity at the 0-th position.

It should be noted that since the distribution of qIdx (quantized-coefficient index) with hidden parity and qIdx with unhidden parity is different (the magnitude of qIdx with hidden parity is about half that with unhidden parity), using different context models when encoding and decoding qIdx can improve encoding performance.

In some embodiments of the present application, the initial value of the context model of the AOM includes four types in terms of the quantization parameter (QP). For example, for encoding qIdx whose parity is hidden, encoding of identification of BR and LR takes the initial values of additional 20×4=80 groups and 28×4=112 groups of context models in total, and the index of the context model is related to whether the coefficient is at the DC position and the absolute values (levels) of the coded quantized coefficients around the position of the current coding qIdx.

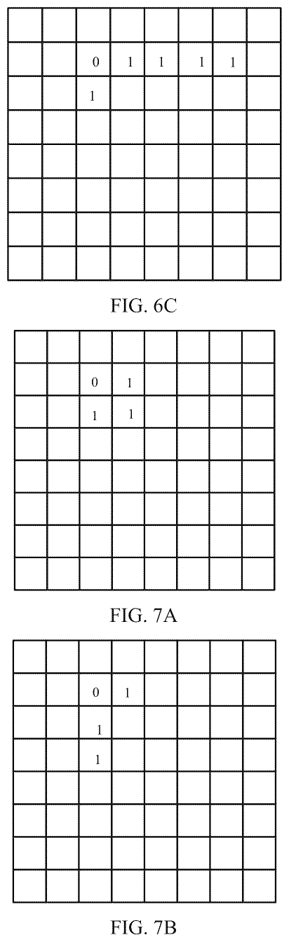

For example, when coding the BR of qIdx with hidden parity, values at positions (e.g., 5 positions) of absolute values of surrounding coded quantized coefficients are referenced for coding. FIG. 6A illustrates five positions of coded levels that need to be referenced in Zig-Zag/Diagonal scan. FIG. 6B illustrates five positions of coded levels that need to be referenced in column scan. FIG. 6C illustrates five positions of coded levels that need to be referenced in row scan. The position where ‘0’ is located represents the current block, and positions where ‘1’ are located are positions of absolute values of referenced surrounding coded quantized coefficients.

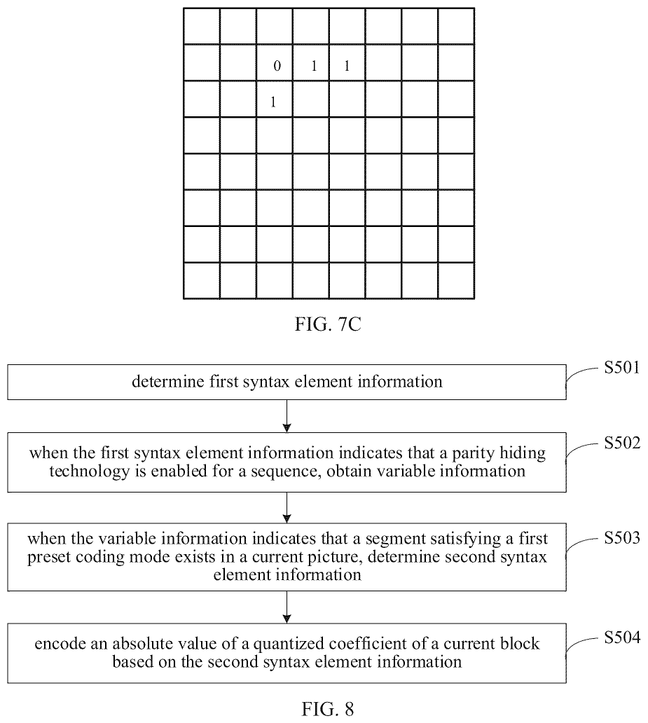

Exemplarily, when coding the LR of qIdx with hidden parity, values at positions (e.g., 3 positions) of absolute values of surrounding coded quantized coefficients are referenced for coding. FIG. 7A illustrates three positions of coded levels that need to be referenced in Zig-Zag/Diagonal scan. FIG. 7B illustrates three positions of coded levels that need to be referenced in column scan. FIG. 7C illustrates three positions of coded levels that need to be referenced in row scan. The position where ‘0’ is located represents the current block, and positions where ‘1’ are located are positions of absolute values of referenced surrounding coded quantized coefficients.

In some embodiments of the present application, when encoding and decoding the current region of the current block, the codec references values at several positions that have been encoded and decoded, to determine the context model index values used when encoding and decoding the hidden quantized coefficients for different colour components of the current block. According to DC coefficient positions and non-DC coefficient positions of different colour components, as well as the difference of BR and LR, the context model index values are different.

For example, as illustrated in Table 3, the context model index values used when encoding and decoding the hidden quantized coefficients for different colour components are Indexes of context model.

TABLE 3

| | Index of context model |
|---|---|
| Luma | |
| BR at DC coefficient position | $min ( 4 , ( ( {\sum }_{Θ} BR ) + 1 ) ≫ 1 )$ |
| BR at non-DC coefficient position | $5 + min ( 4 , ( ( {\sum }_{Θ} BR ) + 1 ) ≫ 1 )$ |
| LR at DC coefficient position | $min ( 6 , ( ( ( {\sum }_{Φ} ( B R + \sum LR ) ) ) + 1 ) ≫ 1 )$ |
| LR at non-DC coefficient positions | $7 + min ( 6 , ( ( ( {\sum }_{Φ} ( B R + \sum LR ) ) ) + 1 ) ≫ 1 )$ |
| Chroma | |
| BR at DC coefficient position | $10 + min ( 4 , ( ( {\sum }_{Θ} BR ) + 1 ) ≫ 1 )$ |
| BR at non-DC coefficient positions | $15 + min ( 4 , ( ( {\sum }_{Θ} BR ) + 1 ) ≫ 1 )$ |
| LR at DC coefficient position | $14 + min ( 6 , ( ( ( {\sum }_{Φ} ( B R + \sum LR ) ) ) + 1 ) ≫ 1 )$ |
| LR at non-DC coefficient positions | $21 + min ( 6 , ( ( ( {\sum }_{Φ} ( B R + \sum LR ) ) ) + 1 ) ≫ 1 )$ |

Θ denotes five positions around the current position in several scanning manners in FIG. 5, Φ denotes three positions around the current position in several scanning manners in FIG. 6.

It can be understood that different context models may be used for encoding and decoding the hidden quantized coefficient and the non-hidden quantized coefficient, and different context models may be used for encoding and decoding different parts of hidden quantized coefficients at different types of coefficient positions of different colour components, thereby improving the diversity of encoding and decoding.

In some embodiments of the present application, the decoder decodes to obtain the absolute values of quantized coefficients of the current block. The absolute value of each quantized coefficient may be represented by one or more multi-symbol identification information. Specifically, according to the magnitude of the absolute value of the quantized coefficient, it may be represented by several types of multi-symbol identification information, such as first identification information, second identification information, third identification information, fourth identification information, and fifth identification information, in segments.

In some embodiments of the present application, the decoder determines the absolute value of the quantized coefficient of the current block in the current region as follows.

The bitstream is parsed to obtain first identification information.

According to the first identification information, determine that the absolute value of the quantized coefficient of the current block is 0, 1, 2, or greater than or equal to 3.

If the absolute value of the quantized coefficient of the current block is greater than or equal to 3, the bitstream is further parsed to obtain the second identification information.

According to the second identification information, determine that the absolute value of the quantized coefficient of the current block is 3, 4, 5, or greater than or equal to 6.

If the absolute value of the quantized coefficient of the current block is greater than or equal to 6, the bitstream is further parsed to obtain the third identification information.

According to the third identification information, determine that the absolute value of the quantized coefficient of the current block is 6, 7, 8 or greater than or equal to 9.

The following is performed on condition that it is determined based on the second syntax element information that a hidden quantized coefficient exists in the current block.

If the absolute value of the quantized coefficient of the current block is greater than or equal to 9, the bitstream is further parsed to obtain fourth identification information.

According to the fourth identification information, determine that the absolute value of the quantized coefficient of the current block is 9, 10, 11 or greater than or equal to 12.

If the absolute value of the quantized coefficient of the current block is greater than or equal to 12, the bitstream is further parsed to obtain fifth identification information.

According to the fifth identification information, determine that the absolute value of the quantized coefficient of the current block is 12, 13, 14, or greater than or equal to 15.

If the absolute value of the quantized coefficient of the current block is greater than or equal to 15, the bitstream is further parsed to determine the absolute value of the quantized coefficient of the current block.

Note that, in embodiments of the present application, five identification information may be provided. That is, first identification information (which may be represented by identification 1), second identification information (which may be represented by identification 2), third identification information (which may be represented by identification 3), fourth identification information (which may be represented by identification 4), and fifth identification information (which may be represented by identification 5), and each identification information may include multiple symbols, specifically, four symbols (0, 1, 2, 3).

The first identification information may be used for decoding a part in which the absolute value of the quantized coefficient of the current block is 0 to 3. The second identification information may be used for decoding a part in which the absolute value of the quantized coefficient of the current block is 3 to 6. The third identification information may be used for decoding a part in which the absolute value of the quantized coefficient of the current block is 6 to 9. The fourth identification information may be used for decoding a part in which the absolute value of the quantized coefficient of the current block is 9 to 12. The fifth identification information may be used for decoding a part in which the absolute value of the quantized coefficient of the current block is 12 to 15.

In a specific embodiment, the first identification information represents the part in which the absolute value of the quantized coefficient is 0 to 3, where there are 4 symbols (0, 1, 2, 3) in total, and when the symbol of the first identification information is 3, the second identification information needs to be further decoded. The second identification information represents the part in which the absolute value of the quantized coefficient is 3 to 6, where there are 4 symbols (0, 1, 2, 3) in total, and when the symbol of the second identification information is 3, the third identification information needs to be further decoded. The third identification information represents the part in which the absolute value of the quantized coefficient is 6 to 9, where there are 4 symbols (0, 1, 2, 3) in total, and when the symbol of the third identification information is 3, the fourth identification information needs to be further decoded. The fourth identification information represents the part in which the absolute value of the quantized coefficient is 9 to 12, where there are 4 symbols (0, 1, 2, 3) in total, and when the symbol of the fourth identification information is 3, the fifth identification information needs to be further decoded. The fifth identification information represents the part in which the absolute value of the quantized coefficient is 12 to 15, where there are 4 symbols (0, 1, 2, 3) in total, and when the symbol of the fifth identification information is 3, the part in which the absolute value of the quantized coefficient is greater than 15 is further decoded.

For example, for the first identification information, if the symbol of the first identification information is 0, it means that the absolute value of the quantized coefficient of the current block is 0; if the symbol of the first identification information is 1, it means that the absolute value of the quantized coefficient of the current block is 1; if the symbol of the first identification information is 2, it means that the absolute value of the quantized coefficient of the current block is 2; if the symbol of the first identification information is 3, it means that the absolute value of the quantized coefficient of the current block is greater than or equal to 3, and in this case, the second identification information needs to be obtained by decoding. For the second identification information, if the symbol of the second identification information is 0, it means that the absolute value of the quantized coefficient of the current block is 3; if the symbol of the second identification information is 1, it means that the absolute value of the quantized coefficient of the current block is 4; if the symbol of the second identification information is 2, it means that the absolute value of the quantized coefficient of the current block is 5; if the symbol of the second identification information is 3, it means that the absolute value of the quantized coefficient of the current block is greater than or equal to 6, and in this case, the third identification information needs to be obtained by decoding. The above is repeated until the fifth identification information is obtained by decoding. For the fifth identification information, if the symbol of the fifth identification information is 0, it means that the absolute value of the quantized coefficient of the current block is 12; if the symbol of the fifth identification information is 1, it means that the absolute value of the quantized coefficient of the current block is 13; if the symbol of the fifth identification information is 2, it means that the absolute value of the quantized coefficient of the current block is 14; if the symbol of the fifth identification information is 3, it means that the absolute value of the quantized coefficient of the current block is greater than or equal to 15. When it is determined that the absolute value of the quantized coefficient of the current block is greater than or equal to 15, the bitstream is further parsed to determine the absolute value of the quantized coefficient of the current block.

It should also be noted that, for decoding the absolute value of the quantized coefficient of the current block, in some embodiments, the method may further include the following.

When the absolute value of the quantized coefficient of the current block is less than 15, the bitstream is parsed using the context model, to determine the absolute value of the quantized coefficient of the current block.

When the absolute value of the quantized coefficient of the current block is greater than or equal to 15, the bitstream is parsed using the bypass model, to determine the absolute value of the quantized coefficient of the current block.

That is, the part greater than or equal to 15 can be decoded using the bypass model (e.g., exponential-Golomb decoding). The first identification information, the second identification information, the third identification information, the fourth identification information, and the fifth identification information (i.e., identification 1˜5) can be decoded using the context model, where the first identification information (i.e., identification 1) has a separate set of context models, and the remaining four identification information (i.e., identification 2˜5) share a set of context models.

It should also be noted that, in embodiments of the present application, decoding the absolute value of the quantized coefficient of the current block may include two loop processes. In some embodiments, the method may further include the following.

When the absolute value of the quantized coefficient of the current block is less than 15, the bitstream is parsed according to a first loop order to determine the absolute value of the quantized coefficient of the current block.

Note that, in the process of parsing the bitstream according to the first loop order, when the codec codes the current block, for the current region of one transform block, when the second syntax element information indicates that the parity hiding technology is enabled, the number of encoded or decoded non-zero quantized coefficients (or other conditions, etc.) can be counted first. When the number of the non-zero quantized coefficients is greater than or equal to the number threshold, it can be determined that the parity hiding technology is applied to the preset position in the current region. In this way, for the non-zero quantized coefficient applying the parity hiding technology and other non-zero quantized coefficient that is un-coded and does not apply the parity hiding technology, the coding can be continued by using different context models.

When the absolute value of the quantized coefficient of the current block is greater than or equal to 15, the bitstream is parsed according to a second loop order to determine the absolute value of the quantized coefficient of the current block.

That is, for the absolute value of the quantized coefficient of the current block, the part of the absolute value of the quantized coefficient less than 15 may be decoded according to the first loop order, and the part of the absolute value of the quantized coefficient greater than or equal to 15 may be decoded according to the second loop order.

In some embodiments, the first loop order and the second loop order each are an order from the last non-zero quantized coefficient of the current block to the upper left position of the current block.

Alternatively, the first loop order is an order from the last non-zero quantized coefficient of the current block to the upper left position of the current block, and the second loop order is an order from the upper left position of the current block to the last non-zero quantized coefficient of the current block.

In one possible implementation, first, identification 1 to 5 are decoded in a loop order from the last non-zero quantized coefficient of the current block to the upper left position (i.e., the upper left corner). Then, according to the loop order from the upper left corner of the current block to the last non-zero quantized coefficient, the part in which the absolute value of the quantized coefficient is greater than or equal to 15 is decoded to determine the absolute value of the quantized coefficient of the current block.

In another possible implementation, identification 1 to 5 are first decoded in the loop order from the last non-zero quantized coefficient of the current block to the upper left corner. Then, still in the loop order from the last non-zero quantized coefficient of the current block to the upper left corner, the part in which the absolute value of the quantized coefficient is greater than or equal to 15 is decoded, to determine the absolute value of the quantized coefficient of the current block.

It can be understood that, at the decoding end, when it is determined according to the first syntax element information that the parity hiding technology is enabled at sequence-level, whether to determine the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the decoder decodes the absolute value of the quantized coefficient of the current block with the parity hiding technology. Thus, according to the high-level syntax (i.e., the second syntax element information) that depends on whether lossy coding (or conversely understood as lossless coding) is adopted, the decoding process using the parity hiding technology can be controlled effectively. Therefore, in the process of decoding, the applicability of using the parity hiding technology can be improved, and with the better applicability of the parity hiding technology, the parity hiding technology is applied to the process of decoding, to reduce the bitrate of decoding and improve the efficiency and performance of decoding.

Hereinafter, other embodiments will be described in detail.

In some embodiments of the present application, a transform block (for example, the current block, that is, when one block has one region and there is one position where parity can be hidden) can no longer hide parities of multiple coefficients, but hide the parity of one coefficient in the transform block, and generally this coefficient is a coefficient in the upper left corner of the transform block, such as a DC coefficient, which is not limited in embodiments of the present application. The parity of this coefficient will be determined based on the parity of the sum of all or part of absolute values of other coefficients in the transform block under the current colour component, and whether a coefficient with hidden parity exists depends on whether the current transform block contains more than a certain number of non-zero coefficients (e.g., three).

In embodiments of the present application, for the parity hiding technology based on the region or the entire transform block, for existence of the coefficient with hidden parity, not only the condition that there are more than a certain number of non-zero coefficients within the defined range needs to be met, but also additional limiting conditions that need to be met (not necessary) may be set. These conditions may be sequence-level, picture-level, segment-level, block-level flag, or may be the transform type, size, or colour component of the current block.

For the picture-level, the variable information includes: picture-level variable information. The second syntax element information includes: picture-level syntax element information. The picture-level syntax element information represents whether the parity hiding technology is enabled at picture-level.

Embodiments of the present application provide another decoding method. The method includes the following.

A bitstream is parsed to determine first syntax element information.

The above procedure is the same as the procedure of S101, and the description thereof is omitted here.

Exemplarily, the first syntax element information is denoted as enable_ph. The logic of obtaining a sequence-level parity-hiding-technology flag by decoding is as follows.

$$sequence\_header \_obu ( ) \{$$

$$…$$

$$enable\_ph$$

$$…$$

sequence_header_obu is a set of a series of sequence header information. enable_ph is a sequence-level parity-hiding-technology flag, if it is 1, it means that the parity hiding technology is enabled for a current sequence of the video, and if it is 0, it means that the parity hiding technology is disabled for the current sequence of the video. f(1) means using one binary identification with equal probability.

When the first syntax element information indicates that the parity hiding technology is enabled for the sequence, the picture-level variable information is obtained.

The above procedure is the same as the procedure of S102, and the description thereof is omitted here.

The difference is that the decoder obtains the picture-level variable information.

Exemplarily, the picture-level variable information may be expressed as CodedLossless.

Here, CodedLossless may be a first value or a second value. If a value of CodedLossless is the first value, it is determined that the second preset coding mode, i.e., lossless coding, is applied to all segments in the current picture. If the value of CodedLossless is the second value, it is determined that the first preset coding mode, that is, lossy coding, is applied to at least one segment in the current picture.

In embodiments of the present application, the first value and the second value are different, and the first value and the second value may be in the form of parameters or numbers. CodedLossless may be a parameter written in the profile, which is not specifically limited herein.

For example, the first value may be set to 1, and the second value may be set to 0, and the embodiments of the present application are not limited.

When the picture-level variable information indicates that at least one segment applying the first preset coding mode exists in the current picture, the picture-level syntax element information is determined.

In embodiments of the present application, after the decoder obtains the picture-level variable information, since the coding mode of the segment in the current picture can be determined according to the picture-level variable information, the decoder parses the picture-level syntax element information when the picture-level variable information indicates that at least one segment satisfying the first preset coding mode exists in the current picture.

For example, when enable_ph (first syntax element information, that is, sequence-level parity-hiding-technology flag) is equal to 1 (i.e., allowed) and the picture-level variable information CodedLossless is equal to 0 (i.e., lossy coding is applied to at least one segment), the decoder determines the picture-level syntax element information allow_ph, that is, picture-level parity-hiding-technology flag. The code logic is identified as follows.

$$if ( ! CodedLossless \&\& enable\_ph )$$

$$allow\_ph$$

In embodiments of the present application, CodedLossless being 1 indicates that lossless coding is applied to all blocks of all segments of the current picture, and CodedLossless being 0 indicates that lossy coding is applied to at least one segment of the current picture. Therefore, the picture-level parity-hiding-technology flag allow_ph is parsed when the current picture is not lossless compressed, that is, CodedLossless is not 1 but is 0, and the sequence-level parity-hiding-technology flag is 1.

In some embodiments of the present application, the picture-level parity-hiding-technology flag allow_ph being 1 indicates that the parity hiding technology can be applied to the current picture, and allow_ph being 0 indicates that the parity hiding technology cannot be applied. When there is no parsing of allow_ph, the value of allow_ph is set to 0.

It should be noted that other implementation principle of the above procedure is consistent with the principle of S103, and the second syntax element information is the picture-level syntax element information, which will not be described here.

When the picture-level syntax element information indicates that the parity hiding technology is enabled for the current picture and the first preset coding mode is applied to the current segment containing the current block, determine whether a hidden quantized coefficient exists in the current block.

In embodiments of the present application, in different segments, enable_ph and allow_ph are equal to 1, but the current segment is lossless encoded. Therefore, in this case, for each block, when determining whether the parity hiding technology is used, if allow_ph is equal to 1 and lossless coding is not used, without other conditions, it is determined that the parity hiding technology is applied to the current block. In other words, when the picture-level syntax element information indicates that the parity hiding technology is allowed for the current picture (allow_ph is 1) and the first preset coding mode (lossy coding) is applied to the current segment containing the current block, in combination with other restrictions, the decoder determines whether a hidden quantized coefficient exists in the current block.

In embodiments of the present application, when the picture-level syntax element information indicates that the parity hiding technology is allowed for the current picture (allow_ph is 1) and the first preset coding mode (lossy coding) is applied to the current segment containing the current block, if no other restrictions are combined, the decoder determines that there is a hidden quantized coefficient in the current block.

When the picture-level syntax element information indicates that the parity hiding technology is allowed for the current picture (allow_ph is 1), and the first preset coding mode (lossy coding) is applied to the current segment containing the current block, if other restrictions (current colour component, current transform type, size of transform block, etc.) are satisfied, the decoder determines that the hidden quantized coefficient exists in the current block.

In some embodiments of the present application, if the picture-level syntax element information indicates that the parity hiding technology is allowed for the current picture (allow_ph is 1) and the second preset coding mode (lossless coding) is applied to the current segment containing the current block, or if the picture-level syntax element information indicates that the parity hiding technology is not allowed for the current picture (allow_ph is 0), it is determined that no hidden quantized coefficient exists in the current block, that is, the parity hiding technology is not used.

When a hidden quantized coefficient exists in the current block, the absolute value of the quantized coefficient of the current block is determined.

It should be noted that other processes of decoding of the absolute value of the quantized coefficient in the above procedures are consistent with the implementation principle in S104, and will not be repeatedly described here.

For example, the picture-level parity-hiding-technology flag is obtained by conditional decoding of the sequence-level flag, as illustrated in Table 4.

TABLE 4

| uncompressed_header( ) { | Type |
|---|---|
| . . . | |
| CodedLossless = 1 | |
| for ( segmentId = 0; segmentId < MAX_SEGMENTS; segmentId++ ) { | |
| qindex = get_qindex( 1, segmentId ) | |
| LosslessArray[ segmentId ] = qindex == 0 && DeltaQYDc == 0 && | |
| DeltaQUAc == 0 && DeltaQUDc == 0 && | |
| DeltaQVAc == 0 && DeltaQVDc == 0 | |
| if ( !LosslessArray[ segmentId ] ) | |
| CodedLossless = 0 | |
| if ( using_qmatrix ) { | |
| if ( LosslessArray[ segmentId ] ) { | |
| SegQMLevel[ 0 ][ segmentId ] = 15 | |
| SegQMLevel[ 1 ][ segmentId ] = 15 | |
| SegQMLevel[ 2 ][ segmentId ] = 15 | |
| } else { | |
| SegQMLevel[ 0 ][ segmentId ] = qm_y | |
| SegQMLevel[ 1 ][ segmentId ] = qm_u | |
| SegQMLevel[ 2 ][ segmentId ] = qm_v | |
| } | |
| } | |
| } | |
| . . . | |
| if(!CodedLossless && enable_ph) | |
| allow_ph | f(1) |
| . . . | |

It can be understood that when the decoder determines that the parity hiding technology is enabled at sequence-level according to the sequence-level parity-hiding-technology flag, the decoder may determine whether to determine the picture-level parity-hiding-technology flag based on the picture-level variable information and the lossy coding mode. In this way, when using the parity hiding technology, the decoder takes into account that: under the condition of adopting the lossy coding mode, the picture-level parity-hiding-technology flag is determined, and when the coding mode of the current segment indicated by the picture-level variable information is lossy, the absolute value of the quantized coefficient of the current block is decoded by using the parity hiding technology. Thus, according to the high-level syntax that depends on whether lossy coding (or conversely understood as lossless coding) is adopted, the decoding process using the parity hiding technology can be controlled effectively. Therefore, in the process of decoding, the applicability of using the parity hiding technology can be improved, and with the better applicability of the parity hiding technology, the parity hiding technology is applied to the process of decoding, to reduce the bitrate of decoding and improve the efficiency and performance of decoding.

For the picture-level, the variable information includes: segment-level variable information. The second syntax element information includes: picture-level syntax element information. The picture-level syntax element information represents whether the parity hiding technology is enabled at picture-level.

Embodiments of the present application provide another decoding method. The method includes the following.

A bitstream is parsed to determine first syntax element information.

The above procedure is the same as the procedure of S101, and the description thereof is omitted here.

When the first syntax element information indicates that the parity hiding technology is enabled for the sequence, the segment-level variable information is obtained.

The above procedure is the same as the procedure of S102, and the description thereof is omitted here.

The difference is that the decoder obtains the segment-level variable information.

Exemplarily, the segment-level variable information may be denoted as SegLossless. The variable information SegLossless indicates whether a segment applying lossless coding exists in the current picture.

In some embodiments of the application, the code logic is as follows.

if ( LosslessArray[ segmentId ] )
SegLossless = 1

SegLossless may be a first value or a second value. If the value of SegLossless is the first value, it is determined that that the second preset coding mode, that is, lossless coding, is applied to at least one segment in the current picture. If the value of SegLossless is the second value, it is determined that the first preset coding mode, that is, lossy coding, is applied to all segments in the current picture.

In embodiments of the present application, the first value and the second value are different, and the first value and the second value may be in the form of parameters or numbers. SegLossless may be a parameter written in the profile, which is not specifically limited herein.

For example, the first value may be set to 1, and the second value may be set to 0, and the embodiments of the present application are not limited.

When the segment-level variable information indicates that the first preset coding mode is applied to each segment in the current picture, the picture-level syntax element information is determined.

In embodiments of the present application, after the decoder obtains the segment-level variable information, since the coding mode of the segment in the current picture can be determined according to the segment-level variable information, the decoder parses the picture-level syntax element information when the segment-level variable information indicates that the first preset coding mode is applied to each segment in the current picture.

For example, when enable_ph (first syntax element information, that is, sequence-level parity-hiding-technology flag) is equal to 1 (that is, allowed) and the segment-level variable information SegLossless is equal to 0 (that is, lossy coding is applied to all segments of the current picture), the decoder determines the picture-level syntax element information allow_ph, that is, picture-level parity-hiding-technology flag. The code logic is identified as follows.
if(!SegLossless && enable_ph)
   allow_ph

In embodiments of the present application, the variable information SegLossless indicates whether a segment applying lossless coding exists in the current picture. When the parity hiding technology is enabled for the current sequence of the video and no segment of the current picture adopts lossless coding, the picture-level parity-hiding-technology flag allow_ph is parsed.

In embodiments of the present application, SegLossless being 0 indicates that lossy coding is applied to all blocks of all segments of the current picture, and SegLossless being 1 indicates that lossy coding is applied to at least one segment of the current picture. Therefore, the picture-level parity-hiding-technology flag allow_ph is parsed when all segments of the current picture are lossy compressed, that is, when SegLossless is 0, and the sequence-level parity-hiding-technology flag is 1.

It should be noted that other implementation principle of the above procedure is consistent with the principle of S103, and the second syntax element information is the picture-level syntax element information, which is not described here.

When the picture-level syntax element information indicates that the parity hiding technology is enabled for the current picture, determine whether a hidden quantized coefficient exists in the current block.

In embodiments of the present application, when the picture-level syntax element information indicates that the parity hiding technology is enabled for the current picture, it has been determined that lossy coding is applied to all segments, and the decoder may perform the parity hiding technology for all segments. Thus, a case in which, for different segments, both enable_ph and allow_ph are 1 but the current segment is lossless encoded can be avoided. Therefore, the decoder may directly determine whether there is a hidden quantized coefficient in the current block in combination with other restrictions when the picture-level syntax element information indicates that the parity hiding technology is enabled for the current picture. In other words, when determining whether the parity hiding technology can be enabled for each block, there is no need to determine whether the current segment is lossless, but it is directly determined whether the parity hiding technology can be used according to the value of allow_ph if no other restrictions are combined.

In embodiments of the present application, when the picture-level syntax element information indicates that the parity hiding technology is allowed for the current picture (allow_ph is 1), the decoder needs to directly determine that there is a hidden quantized coefficient in the current block unless other restrictions are combined.

The decode determines that there is a hidden quantized coefficient in the current block if other restrictions (current colour component, current transform type, size of transform block, etc.) are satisfied in a case where the picture-level syntax element information indicates that the parity hiding technology is allowed for the current picture (allow_ph is 1).

In some embodiments of the present application, if the picture-level syntax element information indicates that the parity hiding technology is not allowed for the current picture (allow_ph is 0), it is determined that there is no hidden quantized coefficient in the current block, that is, the parity hiding technology is not used.

When a hidden quantized coefficient exists in the current block, the absolute value of the quantized coefficient of the current block is determined.

It should be noted that other processes of decoding of the absolute value of the quantized coefficient in the above procedures are consistent with the implementation principle in S104, and will not be repeatedly described here.

For example, the picture-level parity-hiding-technology flag is obtained by conditional decoding of the sequence-level flag, as illustrated in Table 5.

TABLE 5

| uncompressed_header( ) { | Type |
|---|---|
| . . . | |
| CodedLossless = 1 | |
| SegLossless = 0 | |
| for ( segmentId = 0; segmentId < MAX_SEGMENTS; segmentId++ ) { | |
| qindex = get_qindex( 1, segmentId ) | |
| LosslessArray [ segmentId ] = qindex == 0 && DeltaQYDc == 0 && | |
| DeltaQUAc == 0 && DeltaQUDc == 0 && | |
| DeltaQVAc == 0 && DeltaQVDc == 0 | |
| if ( !LosslessArray[ segmentId ] ) | |
| CodedLossless = 0 | |
| if ( LosslessArray[ segmentId ] ) | |
| SegLossless = 1 | |
| if ( using_qmatrix ) { | |
| if ( LosslessArray[ segmentId ] ) { | |
| SegQMLevel[ 0 ][ segmentId ] = 15 | |
| SegQMLevel[ 1 ][ segmentId ] = 15 | |
| SegQMLevel[ 2 ][ segmentId ] = 15 | |
| } else { | |
| SegQMLevel[ 0 ][ segmentId ] = qm_y | |
| SegQMLevel[ 1 ][ segmentId ] = qm_u | |
| SegQMLevel[ 2 ][ segmentId ] = qm_v | |
| } | |
| } | |
| } | |
| . . . | |
| if(!SegLossless && enable_ph) | |
| allow_ph | f(1) |
| . . . | |

It can be understood that when the decoder determines that the parity hiding technology is enabled at sequence-level according to the sequence-level parity-hiding-technology flag, the decoder may determine whether to determine the picture-level parity-hiding-technology flag based on the picture-level variable information and the lossy coding mode. In this way, when using the parity hiding technology, the decoder takes into account that: under the condition that the lossy coding mode is applied to all segments, the picture-level parity-hiding-technology flag is determined, and the absolute value of the quantized coefficient of the current block is decoded by using the parity hiding technology. Thus, according to the high-level syntax that depends on whether lossy coding (or conversely understood as lossless coding) is adopted, the decoding process using the parity hiding technology can be controlled effectively. Therefore, in the process of decoding, the applicability of using the parity hiding technology can be improved, and with the better applicability of the parity hiding technology, the parity hiding technology is applied to the process of decoding, to reduce the bitrate of decoding and improve the efficiency and performance of decoding.

For the slice-level or segment-level, the variable information includes: segment-level variable information. The second syntax element information includes: segment-level syntax element information. The segment-level syntax element information represents whether the parity hiding technology is enabled at segment-level.

Embodiments of the present application provide another decoding method. The method includes the following.

A bitstream is parsed to determine first syntax element information.

The above procedure is the same as the procedure of S101, and the description thereof is omitted here.

When the first syntax element information indicates that the parity hiding technology is enabled for the sequence, the segment-level variable information is obtained.

The above procedure is the same as the procedure of S102, and the description thereof is omitted here.

The difference lies in the variable information. Herein, each segment corresponds to one segment-level variable information, which is different from the meaning of the segment-level variable information in the above procedure that represents the segment as a whole.

In embodiments of the present application, the segment-level variable information represents a coding mode adopted by one segment.

Exemplarily, the segment-level variable information may be represented as LosslessArray[segmentId].

Here, LosslessArray[segmentId] may be a first value or a second value. If a value of LosslessArray[segmentId] is the first value, it is determined that the second preset coding mode, that is, lossless coding, is applied to the current segment. If the value of LosslessArray[segmentId] is the second value, it is determined that the first preset coding mode, that is, lossy coding, is applied to the current segment.

Each segment of the current picture is traversed, and when the segment-level variable information indicates that the first preset coding mode is applied to the current segment in the current picture, the segment-level syntax element information of the current segment is determined.

In embodiments of the present application, the decoder may obtain segment-level variable information corresponding to each segment of the current picture, the decoder traverses the segments of the current picture, and for each segment, determines the coding mode of the current segment according to the segment-level variable information, to determine whether to parse the segment-level syntax element information corresponding to the segment.

It is noted that, when the segment-level variable information corresponding to each segment indicates that the first preset coding mode is applied to the current segment, the segment-level syntax element information of the current segment is parsed, and whether the parity hiding technology is applied to the current block is further determined according to the segment-level syntax element information. When the segment-level variable information corresponding to each segment indicates that the second preset coding mode is applied to the current segment, it indicates that the parity hiding technology is not enabled for the current segment, that is, the parity hiding technology is not applied to the block in the current segment, i.e., the value of allow_ph_seg is 0.

In some embodiments of the present application, when the decoder traverses the segments of the current picture, when the segment-level variable information corresponding to each segment indicates that the first preset coding mode is applied to the current segment, the decoder parses the segment-level syntax element information of the current segment.

Exemplarily, the segment-level syntax element information may be a segment-level parity-hiding-technology flag, denoted as allow_ph_seg.

In embodiments of the present application, allow_ph_seg indicates whether the parity hiding technology is used for the current segment, allow_ph_seg being 1 indicates that the parity hiding technology can be used for the current segment, and allow_ph_seg being 0 indicates that the parity hiding technology cannot be used for the current segment.

It should be noted that the value of allow_ph_seg can be obtained through PhArray [ ], where PhArray [ ] is a variable that stores the value of each segment. PhArray [ ] being 1 indicates that the parity hiding technology can be used for the current segment, and PhArray [ ] being 0 indicates that the parity hiding technology cannot be used for the current segment.

In some embodiments of the present application, whether the parity hiding technology can be used for the transform block depends on the value of PhArray [ ] (for each block, in addition to allow_ph_seg, restrictions such as transform type, size of transform block, colour component of the current block, etc. are considered).

Exemplarily, the code logic is as follows.

```
if(enable_ph) {
  for ( segmentId = 0; segmentId < MAX_SEGMENTS; segmentId++ ) {
    if( !LosslessArray[ segmentId ] ) {
      allow_ph_seg
          PhArray[ segmentId ] = allow_ph_seg
        }
        else
        PhArray[ segmentId ] = 0
  }
```

When the segment-level syntax element information indicates that the parity hiding technology is enabled for the current segment, determine whether a hidden quantized coefficient exists in the current block.

In embodiments of the present application, when the segment-level syntax element information indicates that the parity hiding technology is enabled for the current segment, it has been determined that lossy coding is applied to the current segment, and the decoder may perform the parity hiding technology. Therefore, the decoder may directly determine whether there is a hidden quantized coefficient in the current block in conjunction with other restrictions when the segment-level syntax element information indicates that the parity hiding technology is applied to the current segment. In other words, when determining whether the parity hiding technology can be used for each block, it is not necessary to determine whether the current segment is lossless, but it is directly determined whether the parity hiding technology can be used for the current block according to the value of allow_ph_seg if other restrictions are not combined.

In embodiments of the present application, when the segment-level syntax element information indicates that the parity hiding technology is applied to the current segment (allow_ph_seg is 1), the decoder directly determines that there is a hidden quantized coefficient in the current block unless other restrictions are combined.

The decoder determines that there is a hidden quantized coefficient in the current block if other restrictions (current colour component, current transform type, size of transform block, etc.) are satisfied when the segment-level syntax element information indicates that the parity hiding technology is allowed for the current segment (allow_ph_seg is 1).

In some embodiments of the present application, if the segment-level syntax element information indicates that the parity hiding technology is not allowed for the current segment (allow_ph_seg is 0), or PhArray [ ] is 0, it is determined that there is no hidden quantized coefficient in the current block, that is, the parity hiding technology is not used.

When a hidden quantized coefficient exists in the current block, the absolute value of the quantized coefficient of the current block is determined.

It should be noted that other processes of decoding of the absolute value of the quantized coefficient in the above procedures are consistent with the implementation principle in S104, and will not be repeatedly described here.

For example, when the information set is identified at picture-level, whether the parity hiding technology can be applied to each segment is parsed additionally, and the segment-level parity-hiding-technology flag is obtained by decoding, as illustrated in Table 6.

TABLE 6

| uncompressed_header( ) { | Type |
|---|---|
| . . . | |
| CodedLossless = 1 | |
| for ( segmentId = 0; segmentId < MAX_SEGMENTS; segmentId++ ) { | |
| qindex = get_qindex( 1, segmentId ) | |
| LosslessArray[ segmentId ] = qindex == 0 && DeltaQYDc == 0 && | |
| DeltaQUAc == 0 && DeltaQUDc == 0 && | |
| DeltaQVAc == 0 && DeltaQVDc == 0 | |
| if ( !LosslessArray[ segmentId ] ) | |
| CodedLossless = 0 | |
| if ( using_qmatrix ) { | |
| if ( LosslessArray[ segmentId ] ) { | |
| SegQMLevel[ 0 ][ segmentId ] = 15 | |
| SegQMLevel[ 1 ][ segmentId ] = 15 | |
| SegQMLevel[ 2 ][ segmentId ] = 15 | |
| } else { | |
| SegQMLevel[ 0 ][ segmentId ] = qm_y | |
| SegQMLevel[ 1 ][ segmentId ] = qm_u | |
| SegQMLevel[ 2 ][ segmentId ] = qm_v | |
| } | |
| } | |
| } | |
| . . . | |
| if(enable_ph) { | |
| for ( segmentId = 0; segmentId < MAX_SEGMENTS; segmentId++ ) { | |
| if( !LosslessArray[ segmentId ] ) { | |
| allow_ph_seg | f(1) |
| PhArray[ segmentId ] = allow_ph_seg | |
| } | |
| else | |
| PhArray[ segmentId ] = 0 | |
| } | |
| . . . | |

It can be understood that when the decoder determines that the parity hiding technology is enabled at sequence-level according to the sequence-level parity-hiding-technology flag, the decoder may determine whether to determine the segment-level parity-hiding-technology flag based on the picture-level variable information and the lossy coding mode. In this way, when using the parity hiding technology, the decoder takes into account that: under the condition that the lossy coding mode is applied to the current segment, the segment-level parity-hiding-technology flag is determined, and the absolute value of the quantized coefficient of the current block is decoded by using the parity hiding technology. Thus, according to the high-level syntax that depends on whether lossy coding (or conversely understood as lossless coding) is adopted, the decoding process using the parity hiding technology can be controlled effectively. Therefore, in the process of decoding, the applicability of using the parity hiding technology can be improved, and with the better applicability of the parity hiding technology, the parity hiding technology is applied to the process of decoding, to reduce the bitrate of decoding and improve the efficiency and performance of decoding.

The picture-level parity-hiding-technology flag can reduce the decoded transmission bitstream compared to the segment-level parity-hiding-technology flag.

On the basis of the implementation of the above embodiments, in some embodiments of the present application, for the block-level, the decoder may determine third syntax element information of the current block based on the second syntax element information, where the third syntax element information represents whether the parity hiding technology is enabled at block-level, determine that a hidden quantized coefficient exists in the current block when the third syntax element information indicates that the parity hiding technology is enabled for the current block, and determine the absolute value of the quantized coefficient of the current block when a hidden quantized coefficient exists in the current block.

It should be noted that the third syntax element may be a block-level parity-hiding-technology flag.

In some embodiments of the present application, after determining that the second syntax element information is parsed, regardless of whether the second syntax element information is at picture-level or segment-level, when the second syntax element information indicates that the parity hiding technology is enabled for the segment in the current picture, the decoder may further parse the third syntax element of the current block, and when the third syntax element information indicates that the parity hiding technology is enabled for the current block, the decoder determines that there must be a hidden quantized coefficient in the current block. When there is a hidden quantized coefficient in the current block, the absolute value of the quantized coefficient of the current block is determined.

In embodiments of the present application, the third syntax element information may be a first value or a second value. If the value of the third syntax element information is the first value, it is determined that the parity hiding technology is used for the current block. If the value of the third syntax element information is the second value, it is determined that the parity hiding technology is not used for the current block.

It can be understood that, on the basis of the picture-level parity-hiding-technology flag or the segment-level parity-hiding-technology flag, it is possible to further accurately determine whether there is a hidden quantized coefficient in the current block according to the block-level parity-hiding-technology flag, improving the determination accuracy.

The following illustrates the entire decoding process with an example.

For example, when decoding a block, when determining whether the parity hiding technology is used for the transform block, whether the parity of the upper left corner coefficient of the current block is hidden is determined based on the condition that the current transform block is a luma component, the transform mode is non-Identity Transform in horizontal and vertical directions, and the number of non-zero coefficients is greater than or equal to PHTHRESH (4) except for the upper left corner coefficient. The actual process of decoding the coefficient is illustrated in Table 7 below.

TABLE 7

| | | Comment |
|---|---|---|
| ... | | Decode transform type, last non-zero coefficient position |
| sumAbs1 = 0 | | Initialize the sum in each region |
| num_nz = 0 | | Initialize a counter for non-zero counting for each region |
| for( scanIdx = eob − 1; scanIdx > 1; scanIdx--){ | | Scan from the start point to the penultimate point |
| pos = scan[ scanIdx ] | | Obtain the position of the current scan point in |
| | | the transform block |
| if ( c == ( eob − 1 ) ) { | | |
| coeff_base_eob | S( ) | Decode identification 1 of the last non-zero coefficient |
| level = coeff_base_eob + 1 | | |
| } else { | | |
| coeff_base | S( ) | Decode identification 1 of the last other coefficient |
| level = coeff_base | | |
| } | | |
| if ( level > NUM_BASE_LEVELS ) { | | |
| for ( idx = 0; idx < COEFF_BASE_RANGE | | |
| / ( BR_CDF_SIZE − 1 ); | | |
| idx++ ) { | | |
| coeff_br | S( ) | Decode identification 2~5 according to the condition |
| level += coeff_br | | |
| if ( coeff_br < ( BR_CDF_SIZE − 1 ) ) | | |
| break | | |
| } | | |
| } | | |
| Quant[ pos ] = level | | |
| if(level){ | | |
| num_nz++ | | Count the number of non-zero coefficients |
| sumAbs1 += level | | Accumulate the decoded part |
| } | | |
| } | | |
| isHidePar = num_nz >= PHTHRESH | | Determine according to the number of non-zero |
| | | coefficients in the current region |
| &&condition | | whether parity is hidden |
| && plane_type == PLANE_TYPE_Y | | |
| && primary_tx_type < IDTX | | transform type |
| pos = scan[ scanIdx ] | | Obtain the current position to be decoded |
| if(isHidePar){ | | If the parity is hidden at the current position |
| coeff_base | S( ) | Decode identification 1of the coefficient with |
| | | hidden parity |
| if ( level > NUM_BASE_LEVELS ) { | | |
| for ( idx = 0; idx < COEFF_BASE_RANGE | | |
| / ( BR_CDF_SIZE − 1); idx++ ) { | | |
| coeff_br | S( ) | Decode identification 2-5of the coefficient with |
| | | hidden parity |
| level += coeff_br | | |
| if ( coeff_br < ( BR_CDF_SIZE − 1 ) ) | | |
| break | | |
| } | | |
| } | | |
| } | | |
| else{ | | If the parity is not hidden at the current position |
| coeff_base | S( ) | Decode identification 1of the coefficient |
| if ( level > NUM_BASE_LEVELS ) { | | |
| for ( idx = 0; idx < COEFF_BASE_RANGE | | |
| / ( BR_CDF_SIZE − 1 ); idx++ ) { | | |
| coeff_br | S( ) | Decode identification 2-5of the coefficient |
| level += coeff_br | | |
| if ( coeff_br < ( BR_CDF_SIZE − 1 ) ) | | |
| break | | |
| } | | |
| } | | |
| } | | |
| Quant[ pos ] = (level << isHidePar) | | If the parity is hidden, multiply the whole by 2 |
| if(isHidePar) | | |
| Quant[ pos ] += (sumAbs1 & 1) | | If the parity is hidden, add the hidden parity |
| } | | |
| for ( c = 0; c < eob; c++ ) { | | Decode the remainder and sign of the non-zero |
| | | coefficient |
| pos = scan[ c ] | | |
| if ( Quant[ pos ] != 0 ) { | | |
| if ( c == 0 ) { | | |
| dc_sign | S( ) | |
| sign = dc_sign | | |
| } else { | | |
| sign_bit | L(1) | |
| sign = sign_bit | | |
| } | | |
| } else { | | |
| sign = 0 | | |
| } | | |
| if ( Quant[ pos ] >= | | If the current coefficient is not the coefficient with |
| | | hidden parity, |
| (NUM_BASE_LEVELS + | | then determine whether to decode the remainder |
| COEFF_BASE_RANGE + 1) | | according to whether it is greater than or equal to 15, |
| | | otherwise, determine whether to decode the remainder |
| << (c == 0 && isHidePar)) { | | according to whether it is greater than or equal to 30. |
| length = 0 | | |
| do { | | |
| length++ | | |
| golomb_length_bit | L(1) | |
| } while ( !golomb_length_bit ) | | |
| x = 1 | | |
| for ( i = length − 2; i >= 0; i--) { | | |
| golomb_data_bit | L(1) | |
| x = ( x << 1 ) \| golomb_data_bit | | |
| } | | |
| Quant[ pos ] += x <<(c == 0 && isHidePar) | | Determine whether the remainder is multiplied by 2 |
| | | according to whether the parity is hidden |
| } | | |
| if ( pos == 0 && Quant[ pos ] > 0 ) { | | |
| dcCategory = sign ? 1 : 2 | | Decode the sign |
| } | | |
| Quant[ pos ] = Quant[ pos ] & 0xFFFFF | | |
| culLevel += Quant[ pos ] | | |
| if ( sign ) | | |
| Quant[ pos ] = - Quant[ pos ] | | Assign the sign to the absolute value of the decoded |
| | | coefficient |
| } | | |

Here, isHidePar is a condition of whether the parity of the upper left coefficient of the current block is hidden, and ‘condition’ may replace the information in the above embodiment. Refer to the following.
Replace ‘allow_ph &&!LosslessArray[segmentId]’ in the embodiment, i.e., the parity hiding technology can be applied to the current picture and the current segment is not lossless encoded.
Replace ‘allow_ph’ in the embodiment, i.e., the parity hiding technology can be applied to the current picture.
Replace ‘PhArray [segmentId]’ in the embodiment, i.e., the parity hiding technology can be applied to the current segment.

In another embodiment of the present application, FIG. 8 illustrates a schematic flow chart of an encoding method provided in embodiments of the present application. As illustrated in FIG. 8, the method includes the following.
S501, first syntax element information is determined.
S502, when the first syntax element information indicates that a parity hiding technology is enabled for a sequence, variable information is obtained.

For embodiments of the present application, in AVM, identification information corresponding to a certain non-zero quantized coefficient is hidden by using the parity or other characteristics of the absolute value(s) of the non-zero quantized coefficient(s) included in the current region, which can further improve coding performance. The syntax element is designed to improve the applicability of the parity hiding technology, and with the application of the parity hiding technology, the identification information of the non-zero quantized coefficient can be hidden, thereby saving bitrate and improving encoding and decoding performance.

Before encoding the current sequence of the video to be processed, the encoder may first determine whether the parity hiding technology is enabled, that is, determine the first syntax element information, i.e., the sequence-level parity-hiding-technology flag.

The first syntax element information represents a sequence-level flag. In embodiments of the present application, in a scenario where the parity hiding technology is used, the first syntax element information may exemplarily be a sequence-level parity-hiding-technology flag. The first syntax element information represents, for the current sequence of the video, whether the parity hiding technology is enabled for the sequence.

In embodiments of the present application, the first syntax element information may be a first value or a second value. If a value of the first syntax element information is the first value, it is determined that the first syntax element information (i.e., the sequence-level parity-hiding-technology flag) indicates that the parity hiding technology is enabled for the current sequence of the video to be processed. If the value of the first syntax element information is the second value, it is determined that the first syntax element information indicates that the parity hiding technology is disabled for the current sequence of the video to be processed.

In some embodiments of the present application, when the first syntax element information represents that the parity hiding technology is enabled, the encoder obtains the variable information to determine whether to generate subordinate syntax element information (subordinate parity-hiding-technology flag, that is, second syntax element information).

It is noted that the variable information may include picture-level variable information and segment-level variable information. The variable information represents whether lossy coding (i.e., the first preset coding mode) is applied, where the picture-level variable information represents whether the lossy coding mode is applied to the current picture, and the segment-level variable information represents whether the lossy coding mode is applied to the current segment.

In embodiments of the present application, the variable information can be directly obtained by other information in the decoding process, and the embodiment of the present application is not limited.
S503, when the variable information indicates that a segment satisfying a first preset coding mode exists in a current picture, second syntax element information is determined.

It should be noted that the implementation procedure of S503 is the same as the implementation procedure of S103, and the description thereof will not be repeated here.

For determining of the second syntax element information by the encoder when the variable information indicates that a segment satisfying a first preset coding mode exists in a current picture, the difference is as follows. When the variable information indicates that a segment satisfying the first preset coding mode is present in the current picture, the encoder generates the second syntax element information rather than parses the second syntax element information.

The second syntax element information represents a picture-level flag or a segment-level flag. The first preset coding mode is a lossy coding mode.

It can be understood that the encoder generates the second syntax element information by depending on whether a coding mode adopted by the current picture or the current segment in the current picture that are to be processed is the first preset coding mode, and generates the second syntax element information when the coding mode adopted is the first preset coding mode. This is because, if the coding mode adopted by the current picture or the current segment in the current picture is the second preset coding mode, the parity hiding technology is not adopted, and the second syntax element information is not necessary to be generated. In this case, the encoder can already make it clear that the parity hiding technology is not considered when decoding the current picture or the current segment in the current picture, and there is no need to spend time to generate the second syntax element information to inform the decoder of the parsing, which can effectively improve the decoding efficiency and reduce the bitrate, thereby improving the encoding performance.
S504, an absolute value of a quantized coefficient of a current block is encoded based on the second syntax element information.

In some embodiments of the present application, when the encoder knows whether the parity hiding technology is applied to the current picture or the segment in the current picture, the encoder generates the second syntax element information. If the parity hiding technology is applied to the current picture or the segment in the current picture, it is sometimes necessary to further determine whether the parity hiding technology is applied to the current block. Therefore, when the encoder determines based on the second syntax element information that there is a hidden quantized coefficient in the current block, the encoder can encode the absolute value of the quantized coefficient of the current block.

It should be noted that the encoder determines that a hidden quantized coefficient exists in the current block, which means that the parity hiding technology is used for encoding the current block.

In some embodiments of the present application, the current block may include multiple transform blocks, and each transform block may be partitioned into one or more regions. Taking the current region as an example, when the absolute value of the quantized coefficient of the current block is scanned according to a preset scan order, whether there is a hidden quantized coefficient with hidden identification in the current region is first determined. If it is determined that there is a hidden quantized coefficient in the current region, it is necessary to hide the identification information corresponding to the hidden quantized coefficient, that is, the identification information corresponding to the hidden quantized coefficient is not encoded/decoded. Then, the identification information corresponding to the hidden quantized coefficient is directly determined according to the related characteristics of the absolute value(s) of the non-zero quantized coefficient(s) in the current region. That is, when encoding, the encoder needs to encode the identification information corresponding to the hidden quantized coefficient through the related characteristics of the absolute value of the non-zero quantized coefficient.

It should be noted that, the description of the region partition, the scan manner, and the like is consistent with the description of the decoder, and will not be repeatedly described here.

It can also be understood that, after region partition, for at least one region obtained, the steps of determining whether there is a hidden quantized coefficient with hidden identification and how to determine the identification information corresponding to the hidden quantized coefficient are the same for each region, and the following merely describes the current region as an example.

In some embodiments of the present application, the absolute value of the quantized coefficient of the current block based on the second syntax element information is encoded as follows. The encoder encodes the absolute value of the quantized coefficient of the current block, when it is determined, according to the second syntax element information and at least one of the number of encoded non-zero quantized coefficients, a colour component of the current block, or a transform type of the current block, that a hidden quantized coefficient exists in the current block.

It should be noted that the encoder determines that a hidden quantized coefficient exists in the current block according to the second syntax element information and the number of encoded non-zero quantized coefficients, according to the second syntax element information and the colour component of the current block, according to the second syntax element information and the transform type of the current block, according to the second syntax element information, the number of encoded non-zero quantized coefficients, and the colour component of the current block, according to the second syntax element information, the number of encoded non-zero quantized coefficients, and the transform type of the current block, according to the second syntax element information, the colour component of the current block, and the transform type of the current block, according to the second syntax element information, the number of encoded non-zero quantized coefficients, the colour component of the current block, and the transform type of the current block.

For example, in embodiments of the present application, when the encoder generates that the second syntax element information indicates that the parity hiding technology is used, the encoder scans the absolute values of the encoded quantized coefficients in the current region of the current block according to the preset scan order, to determine the number of the encoded non-zero quantized coefficients in the current region. According to the number of the non-zero quantized coefficients, whether there is a hidden quantized coefficient with hidden identification in the current region is determined.

In embodiments of the present application, if the number of the non-zero quantized coefficients is greater than or equal to a number threshold, it is determined that there is a hidden quantized coefficient in the current region. If the number of the non-zero quantized coefficients is less than the number threshold, it is determined that there is no hidden quantized coefficient in the current region.

In some embodiments of the present application, the encoder determines that a hidden quantized coefficient exists in the current block when the second syntax element information indicates that the parity hiding technology is enabled and at least one of the following being satisfied: the number of the encoded non-zero quantized coefficients is greater than or equal to the number threshold, the colour component of the current block is a preset component, or the transform type of the current block is a preset transform type. The encoder encodes the absolute value of the quantized coefficient of the current block when a hidden quantized coefficient exists in the current block.

Note that, in a case where the second syntax element information indicates that the parity hiding technology is enabled, in combination with at least one of: the number of encoded non-zero quantized coefficients is greater than or equal to the number threshold, the colour component of the current block is the preset component, or the transform type of the current block is the preset transform type, it is determined that a hidden quantized coefficient exists in the current block. Otherwise, it is determined that no hidden quantized coefficient exists in the current block.

The description of the colour component, the transform type, and the like, and the description of the hidden position, the selection process of the context model, and the like are consistent with the description of the decoder, and will not be repeatedly described here.

In some embodiments of the present application, the encoder signals the first syntax element information and the second syntax element information into the bitstream.

In some embodiments of the present application, when the encoder encodes the absolute value of the quantized coefficient of the current block, the absolute value of each quantized coefficient may be represented by one or more multi-symbol identification information. Specifically, according to the magnitude of the absolute value of the quantized coefficient, it may be represented by several types of multi-symbol identification information, such as first identification information, second identification information, third identification information, fourth identification information, and fifth identification information, in segments.

Further, after the absolute value of the quantized coefficient of the current block is determined, the absolute value of the quantized coefficient is encoded and signalled into the bitstream. Thus, in some embodiments, the method may further include the following.

If the absolute value of the quantized coefficient of the current block is 0, 1, 2, or greater than or equal to 3, the first identification information is determined, the first identification information is encoded, and the obtained encoded bit is signalled into the bitstream.

If the absolute value of the quantized coefficient of the current block is 3, 4, 5 or greater than or equal to 6, the second identification information is further determined, the second identification information is encoded, and the obtained encoded bit is signalled into the bitstream.

If the absolute value of the quantized coefficient of the current block is 6, 7, 8 or greater than or equal to 9, the third identification information is further determined, the third identification information is encoded, and the obtained encoded bit is signalled into the bitstream.

If the absolute value of the quantized coefficient of the current block is 9, 10, 11 or greater than or equal to 12, the fourth identification information is further determined, the fourth identification information is encoded, and the obtained encoded bit is signalled into the bitstream.

If the absolute value of the quantized coefficient of the current block is 12, 13, 14 or greater than or equal to 15, the fifth identification information is further determined, the fifth identification information is encoded, and the obtained encoded bit is signalled into the bitstream.

If the absolute value of the quantized coefficient of the current block is greater than or equal to 15, the absolute value of the quantized coefficient of the current block is further encoded, and the obtained encoded bit is signalled into the bitstream.

It should be noted that the description of the identification information is consistent with the description of the decoder, and the description thereof will not be repeated here.

It should be noted that, in some embodiments, the method may further include the following.

When the absolute value of the quantized coefficient of the current block is less than 15, in a first loop order, the first identification information, the second identification information, the third identification information, the fourth identification information, and the fifth identification information are encoded using a context model, and the obtained encoded bits are signalled into the bitstream.

When the absolute value of the quantized coefficient of the current block is greater than or equal to 15, in a second loop order, the absolute value of the quantized coefficient of the current block is encoded using a bypass model, and the obtained encoded bits are signalled into the bitstream.

That is, the part greater than or equal to 15 can be encoded using the bypass model (e.g., exponential-Golomb decoding). The first identification information, the second identification information, the third identification information, the fourth identification information, and the fifth identification information (i.e., identification 1˜5) can be encoded using the context model, where the first identification information (i.e., identification 1) has a separate set of context models, and the remaining four identification information (i.e., identification 2˜5) share a set of context models.

In addition, in embodiments of the present application, encoding the absolute value of the quantized coefficient of the current block may include two loop processes: encoding the identification 1 to 5 according to the first loop order, and encoding the part of the absolute value of the quantized coefficient greater than or equal to 15 according to the second loop order.

It can be understood that, at the encoding end, when it is determined according to the first syntax element information that the parity hiding technology is enabled at sequence-level, whether to generate the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the encoder encodes the absolute value of the quantized coefficient of the current block with the parity hiding technology. Thus, according to the high-level syntax (i.e., the second syntax element information) that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding and decoding, to reduce the bitrate of encoding and improve the efficiency and performance of encoding.

Hereinafter, other embodiments will be described in detail.

In some embodiments of the present application, a transform block (for example, the current block, that is, when one block has one region and there is one position where parity can be hidden) can no longer hide parities of multiple coefficients, but hide the parity of one coefficient in the transform block, and generally this coefficient is a coefficient in the upper left corner of the transform block, such as a DC coefficient, which is not limited in embodiments of the present application. The parity of this coefficient will be determined based on the parity of the sum of all or part of absolute values of other coefficients in the transform block under the current colour component, and whether a coefficient with hidden parity exists depends on whether the current transform block contains more than a certain number of non-zero coefficients (e.g., three).

In embodiments of the present application, for the parity hiding technology based on the region or the entire transform block, for existence of the coefficient with hidden parity, the condition that there are more than a certain number of non-zero coefficients within the defined range is not only to be met, but also additional limiting conditions that need to be met (not necessary) may be set. These conditions may be sequence-level, picture-level, segment-level, block-level flag, or may be the transform type, size, or colour component of the current block.

For the picture-level, the variable information includes: picture-level variable information. The second syntax element information includes: picture-level syntax element information. The picture-level syntax element information represents whether the parity hiding technology is enabled at picture-level.

Embodiments of the present application provide another encoding method. The method includes the following.

First syntax element information is determined.

When the first syntax element information indicates that a parity hiding technology is enabled for a sequence, picture-level variable information is obtained.

When the picture-level variable information indicates that at least one segment applying a first preset coding mode exists in a current picture, the picture-level syntax element information is determined.

When the picture-level syntax element information indicates that the parity hiding technology is enabled for the current picture and the first preset coding mode is applied to the current segment containing the current block, determine whether a hidden quantized coefficient exists in the current block.

When a hidden quantized coefficient exists in the current block, the absolute value of the quantized coefficient of the current block is encoded.

It should be noted that the implementation principle of the above procedures is consistent with the implementation principle of the procedures on the decoder, and will not be repeated here.

The difference is that: the decoder decodes to determine the absolute value of the quantized coefficient while the encoder encodes the absolute value of the quantized coefficient. Furthermore, the process of determining the syntax element by the encoder is: in the encoding process, in the case that the parity hiding technology is enabled at sequence-level and picture-level, generating the sequence-level flag and the picture-level flag, and then signalling the sequence-level flag and the picture-level flag into the bitstream in the form of the first syntax element information and the second syntax element information.

It can be understood that when the encoder determines that the parity hiding technology is enabled at sequence-level according to the sequence-level parity-hiding-technology flag, the encoder may determine whether to determine the picture-level parity-hiding-technology flag based on the picture-level variable information and the lossy coding mode. In this way, when using the parity hiding technology, the encoder takes into account that: under the condition of adopting the lossy coding mode, the picture-level parity-hiding-technology flag is determined, and when the coding mode of the current segment indicated by the picture-level variable information is lossy, the absolute value of the quantized coefficient of the current block is encoded by using the parity hiding technology. Thus, according to the high-level syntax that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding, to reduce the bitrate of encoding and improve the efficiency and performance of encoding.

For the picture-level, the variable information includes: segment-level variable information. The second syntax element information includes: picture-level syntax element information. The picture-level syntax element information represents whether the parity hiding technology is enabled at picture-level.

Embodiments of the present application provide another encoding method. The method includes the following.

First syntax element information is determined.

When the first syntax element information indicates that the parity hiding technology is enabled for the sequence, the segment-level variable information is obtained.

When the segment-level variable information indicates that the first preset coding mode is applied to each segment in the current picture, the picture-level syntax element information is determined.

When the picture-level syntax element information indicates that the parity hiding technology is enabled for the current picture, determine whether a hidden quantized coefficient exists in the current block.

When a hidden quantized coefficient exists in the current block, the absolute value of the quantized coefficient of the current block is encoded.

It should be noted that the implementation principle of the above procedures is consistent with the implementation principle of the above procedures on the decoder, and will not be repeatedly described here.

The difference is that: the decoder decodes to determine the absolute value of the quantized coefficient while the encoder encodes the absolute value of the quantized coefficient. Furthermore, the process of determining the syntax element by the encoder is: in the encoding process, in the case that the sequence-level flag and the picture-level flag indicate that the parity hiding technology is enabled, generating the sequence-level flag and the picture-level flag, and then signalling the sequence-level flag and the picture-level flag into the bitstream in the form of the first syntax element information and the second syntax element information.

It can be understood that when the encoder determines that the parity hiding technology is enabled at sequence-level according to the sequence-level parity-hiding-technology flag, the encoder may determine whether to determine the picture-level parity-hiding-technology flag based on the picture-level variable information and the lossy coding mode. In this way, when using the parity hiding technology, the encoder takes into account that: under the condition that the lossy coding mode is applied to all segments, the picture-level parity-hiding-technology flag is determined, and the absolute value of the quantized coefficient of the current block is encoded by using the parity hiding technology. Thus, according to the high-level syntax that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding, to reduce the bitrate of encoding and improve the efficiency and performance of encoding.

For the slice-level or segment-level, the variable information includes: segment-level variable information. The second syntax element information includes: segment-level syntax element information. The segment-level syntax element information represents whether the parity hiding technology is enabled at segment-level.

Embodiments of the present application provide another encoding method. The method includes the following.

First syntax element information is determined.

When the first syntax element information indicates that the parity hiding technology is enabled for the sequence, the segment-level variable information is obtained.

Each segment of the current picture is traversed, and when the segment-level variable information indicates that the first preset coding mode is applied to the current segment in the current picture, the segment-level syntax element information of the current segment is determined.

When the segment-level syntax element information indicates that the parity hiding technology is enabled for the current segment, determine whether a hidden quantized coefficient exists in the current block.

When a hidden quantized coefficient exists in the current block, the absolute value of the quantized coefficient of the current block is encoded.

It should be noted that the implementation principle of the above procedures is consistent with the implementation principle of the above procedures on the decoder, and will not be repeated here.

The difference is that the decoder decodes to determine the absolute value of the quantized coefficient, while the encoder encodes the absolute value of the quantized coefficient. Furthermore, the process of determining the syntax element by the encoder is: in the encoding process, in the case that the sequence-level flag and the segment-level flag indicate that the parity hiding technology is enabled, generating the sequence-level flag and the segment-level flag, and then signalling the sequence-level flag and the segment-level flag into the bitstream in the form of the first syntax element information and the second syntax element information.

It can be understood that when the encoder determines that the parity hiding technology is enabled at sequence-level according to the sequence-level parity-hiding-technology flag, the encoder may determine whether to determine the segment-level parity-hiding-technology flag based on the picture-level variable information and the lossy coding mode. In this way, when using the parity hiding technology, the encoder takes into account that: under the condition that the lossy coding mode is applied to the current segment, the segment-level parity-hiding-technology flag is determined, and the absolute value of the quantized coefficient of the current block is encoded by using the parity hiding technology. Thus, according to the high-level syntax that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding, to reduce the bitrate of encoding and improve the efficiency and performance of encoding.

The picture-level parity-hiding-technology flag can reduce the encoded transmission bitstream compared to the segment-level parity-hiding-technology flag.

On the basis of the implementation of the above embodiments, in some embodiments of the present application, for the block-level, the encoder may determine third syntax element information of the current block based on the second syntax element information, where the third syntax element information represents whether the parity hiding technology is enabled at block-level, determine that a hidden quantized coefficient exists in the current block when the third syntax element information indicates that the parity hiding technology is enabled for the current block, and encode the absolute value of the quantized coefficient of the current block when a hidden quantized coefficient exists in the current block.

It should be noted that the third syntax element may be a block-level parity-hiding-technology flag.

In some embodiments of the present application, after the second syntax element information is determined, regardless of whether the second syntax element information is at picture-level or segment-level, when the second syntax element information indicates that the parity hiding technology is enabled for the segment in the current picture, the encoder may further determine the third syntax element of the current block, and when the third syntax element information indicates that the parity hiding technology is enabled for the current block, the encoder determines that there must be a hidden quantized coefficient in the current block. When there is a hidden quantized coefficient in the current block, the absolute value of the quantized coefficient of the current block is determined.

In embodiments of the present application, the third syntax element information may be a first value or a second value. If the value of the third syntax element information is the first value, it is determined that the parity hiding technology is used for the current block. If the value of the third syntax element information is the second value, it is determined that the parity hiding technology is not used for the current block.

In some embodiments of the present application, the method further includes the following. The third syntax element information is signalled into the bitstream, for use of decoding of the decoder.

It can be understood that, on the basis of the picture-level parity-hiding-technology flag or the segment-level parity-hiding-technology flag, it is possible to further accurately determine whether there is a hidden quantized coefficient in the current block according to the block-level parity-hiding-technology flag, improving the determination accuracy.

In still another embodiment of the present application, the embodiment of the present application further provides a bitstream. The bitstream is generated by bit coding according to information to be encoded, and the information to be encoded includes at least one of: first syntax element information, second syntax element information, third syntax element information, encoding information of an absolute value of a quantized coefficient of a current block, and a preset parameter value, where the first syntax element information indicates whether a parity hiding technology is applied to a sequence, the second syntax element information indicates whether the parity hiding technology is applied at picture-level or segment-level, and the third syntax element information indicates whether the parity hiding technology is applied at block-level, and the preset parameter value includes at least one of: a number threshold, a preset component, and a preset transform type.

It can be understood that after the information to be encoded is bit-encoded to generate the bitstream, the bitstream is transmitted from the encoding end to the decoding end. Then, at the decoding end, whether the identification hiding technology is applied to the current block can be determined by parsing the bitstream. The number threshold, the preset component, the preset transform type, etc. can be determined by parsing the bitstream. The absolute value of the quantized coefficient of the current block can also be determined by parsing the bitstream.

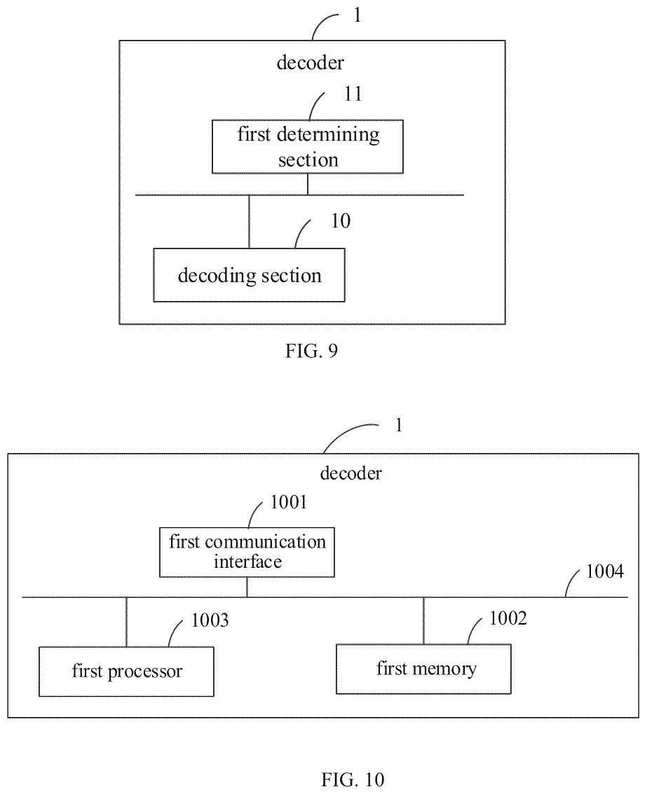

In still another embodiment of the present application, based on the same inventive concept as the above-described embodiments, FIG. 9 illustrates a schematic diagram of a structure of decoder 1 provided in embodiments of the present application. As illustrated in FIG. 9, the decoder 1 includes a decoding section 10 and a first determining section 11.

The decoding section 10 is configured to parse a bitstream to determine first syntax element information. The first determining section 11 is configured to obtain variable information in response to the first syntax element information indicating that a parity hiding technology is enabled for a sequence. The decoding section 10 is further configured to: determine second syntax element information in response to the variable information indicating that a segment satisfying a first preset coding mode exists in a current picture, and determine an absolute value of a quantized coefficient of a current block, in response to determining, based on the second syntax element information, that a hidden quantized coefficient exists in the current block.

In some embodiments of the present application, the variable information includes picture-level variable information, and the second syntax element information includes picture-level syntax element information and the picture-level syntax element information represents whether the parity hiding technology is enabled at picture-level. The first determining section 11 is further configured to determine the picture-level syntax element information in response to the picture-level variable information indicating that at least one segment applying the first preset coding mode exists in the current picture.

In some embodiments of the present application, the decoding section 10 is further configured to: determine whether a hidden quantized coefficient exists in the current block in response to the picture-level syntax element information indicating that the parity hiding technology is enabled for the current picture and the first preset coding mode is applied to a current segment containing the current block; and determine the absolute value of the quantized coefficient of the current block in response to that a hidden quantized coefficient exists in the current block.

In some embodiments of the present application, variable information includes segment-level variable information, and the second syntax element information includes picture-level syntax element information and the picture-level syntax element information represents whether the parity hiding technology is enabled at picture-level. The first determining section 11 is further configured to determine the picture-level syntax element information in response to the segment-level variable information indicating that the first preset coding mode is applied to each segment in the current picture.

In some embodiments of the present application, the decoding section 10 is further configured to: determine whether a hidden quantized coefficient exists in the current block in response to the picture-level syntax element information indicating that the parity hiding technology is enabled for the current picture; and determine the absolute value of the quantized coefficient of the current block in response to that a hidden quantized coefficient exists in the current block.

In some embodiments of the present application, the variable information includes segment-level variable information, and the second syntax element information includes segment-level syntax element information and the segment-level syntax element information represents whether the parity hiding technology is enabled at segment-level. The first determining section 11 is further configured to traverse each segment of the current picture, and determining the segment-level syntax element information of a current segment in response to the segment-level variable information indicating that the first preset coding mode is applied to the current segment in the current picture.

In some embodiments of the present application, the decoding section 10 is further configured to: determine whether a hidden quantized coefficient exists in the current block in response to the segment-level syntax element information indicating that the parity hiding technology is enabled for the current segment; and determine the absolute value of the quantized coefficient of the current block in response to that a hidden quantized coefficient exists in the current block.

In some embodiments of the present application, the decoding section 10 is further configured to: determine third syntax element information of the current block based on the second syntax element information, where the third syntax element information represents whether the parity hiding technology is enabled at block-level; determine that a hidden quantized coefficient exists in the current block in response to the third syntax element information indicating that the parity hiding technology is enabled for the current block; and determine the absolute value of the quantized coefficient of the current block in response to that a hidden quantized coefficient exists in the current block.

In some embodiments of the present application, the determining section 10 is further configured to: determine the absolute value of the quantized coefficient of the current block, in response to determine, according to the second syntax element information and at least one of the number of decoded non-zero quantized coefficients, a colour component of the current block, or a transform type of the current block, that a hidden quantized coefficient exists in the current block.

In some embodiments of the present application, the decoding section 10 is further configured to: determine that a hidden quantized coefficient exists in the current block in response to the second syntax element information indicating that the parity hiding technology is enabled and at least one of the following being satisfied: the number of the decoded non-zero quantized coefficients is greater than or equal to a number threshold, the colour component of the current block is a preset component, or the transform type of the current block is a preset transform type; and determine the absolute value of the quantized coefficient of the current block in response to that a hidden quantized coefficient exists in the current block.

In some embodiments of the present application, the first preset coding mode is a lossy coding mode.

In some embodiments of the present application, the first syntax element information represents a sequence-level flag; the second syntax element information represents a picture-level flag or a segment-level flag.

Based on the structure of the decoder 1 and the computer storage medium described above, FIG. 10 illustrates a schematic diagram of a specific hardware structure of the decoder provided in embodiments of the present application. As illustrated in FIG. 10, the decoder may include: a first communication interface 1001, a first memory 1002, and a first processor 1003. The various components are coupled together via a first bus system 1004. It will be appreciated that the first bus system 1004 is used to enable connection and communication among these components. The first bus system 1004 includes a power bus, a control bus, and a status signal bus in addition to a data bus. However, for the sake of clarity of illustration, various buses are designated as the first bus system 1004 in FIG. 10.

The first communication interface 1001 is configured to receive and transmit signals in the process of transmitting and receiving information with other external network elements.

The first memory 1002 is configured to store a computer program capable of running on the first processor 1003.

The first processor 1003 is configured to execute the decoding method implemented by the decoder when running the computer program.

It can be understood that the first memory 1002 in embodiments of the present application may be a volatile memory or a non-volatile memory, or may include both volatile and non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which serves as an external cache. By way of illustration but not limitation, many forms of RAM are available, such as static random access memory (SRAM), dynamic random access memory (DRAM), synchronous dynamic random access memory (SDRAM), double data rate synchronous dynamic random access memory (DDRSDRAM), enhanced SDRAM (ESDRAM), synchlink dynamic random access memory (SLDRAM), and direct Rambus random access memory (DRRAM). The first memory 1002 of the system and method described herein is intended to include, but is not limited to, these and any other suitable type of memory.

The first processor 1003 may be an integrated circuit chip having signal processing capabilities. In implementation, the steps of the above-described method may be accomplished by an integrated logic circuit of hardware in the first processor 1003 or instructions in the form of software. The above-described first processor 1003 may be a general-purpose processor, a digital signal processor (DSP), an application specific integrated circuit (ASIC), a field programmable gate array (FPGA) or other programmable logic device, a discrete gate or transistor logic device, or a discrete hardware component. The methods, steps, and logical block diagrams disclosed in the embodiments of the present application may be implemented or executed. The general purpose processor may be a microprocessor or the processor may be any conventional processor or the like. The steps of the method disclosed in connection with the embodiments of the present application may be directly embodied as execution by the hardware decoding processor, or may be executed by combining hardware in the decoding processor and the software module. The software module may be located in a storage medium mature in the art, such as random access memory, flash memory, read-only memory, programmable read-only memory, or electrically erasable and writable programmable memory, registers, etc. The storage medium is located in the first memory 1002, and the first processor 1003 reads the information in the first memory 1002, and completes the steps of the above method in combination with its hardware.

It will be appreciated that the embodiments described herein may be implemented in hardware, software, firmware, middleware, microcode, or a combination thereof. For hardware implementation, the processing unit may be implemented in one or more application specific integrated circuits (ASICs), digital signal processors (DSPs), digital signal processing devices (DSPDs), programmable logic devices (PLDs), field-programmable gate arrays (FPGAs), general purpose processors, controllers, microcontrollers, microprocessors, other electronic units for performing the functions described herein, or combinations thereof. For software implementations, the technology described herein may be implemented by performing modules (e.g., procedures, functions, etc.) having the functions described herein. The software code may be stored in memory and executed by a processor. The memory may be implemented in the processor or external to the processor.

It can be understood that the decoding end, when it is determined according to the first syntax element information that the parity hiding technology is enabled at sequence-level, whether to determine the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the decoder decodes the absolute value of the quantized coefficient of the current block with the parity hiding technology. Thus, according to the high-level syntax (i.e., the second syntax element information) that depends on whether lossy coding (or conversely understood as lossless coding) is adopted, the decoding process using the parity hiding technology can be controlled effectively. Therefore, in the process of decoding, the applicability of using the parity hiding technology can be improved, and with the better applicability of the parity hiding technology, the parity hiding technology is applied to the process of decoding, to reduce the bitrate of decoding and improve the efficiency and performance of decoding.

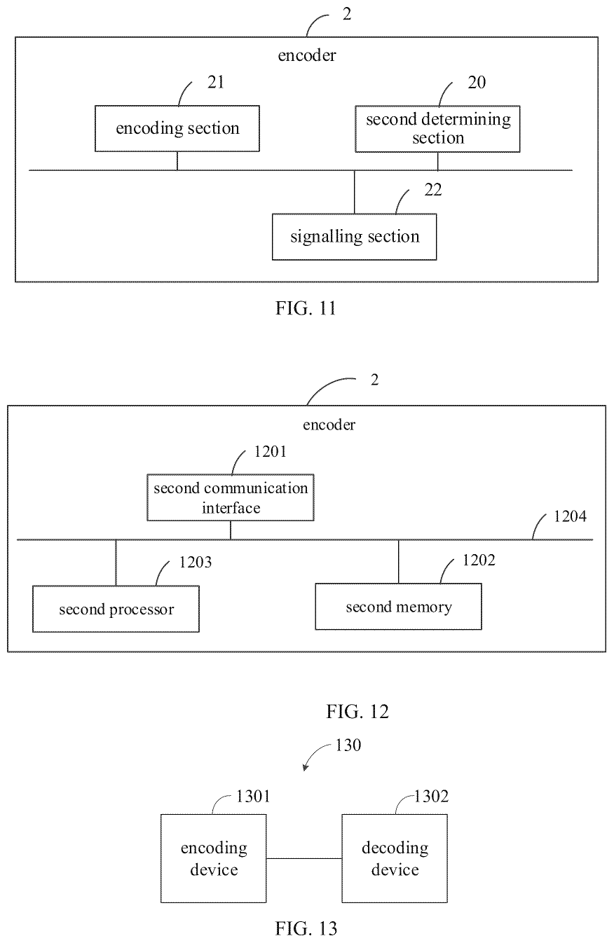

In still another embodiment of the present application, based on the same inventive concept as the above-described embodiments, FIG. 11 illustrates a schematic diagram of a structure of encoder 2 provided in embodiments of the present application. As illustrated in FIG. 11, the encoder 2 includes a second determining section 20 and an encoding section 21.

The second determining section 20 is configured to: determine first syntax element information, obtain variable information in response to the first syntax element information indicating that a parity hiding technology is enabled for a sequence, determine second syntax element information in response to the variable information indicating that a segment satisfying a first preset coding mode exists in a current picture. The encoding section 21 is configured to encode an absolute value of a quantized coefficient of a current block based on the second syntax element information.

In some embodiments of the present application, t the variable information includes picture-level variable information, and the second syntax element information includes picture-level syntax element information and the picture-level syntax element information represents whether the parity hiding technology is enabled at picture-level. The second determining section 20 is further configured to determine the picture-level syntax element information in response to the picture-level variable information indicating that at least one segment applying the first preset coding mode exists in the current picture.

In some embodiments of the present application, the encoding section 21 is further configured to: determine whether a hidden quantized coefficient exists in the current block in response to the picture-level syntax element information indicating that the parity hiding technology is enabled for the current picture and the first preset coding mode is applied to a current segment containing the current block; and encode the absolute value of the quantized coefficient of the current block in response to that a hidden quantized coefficient exists in the current block.

In some embodiments of the present application, the variable information includes segment-level variable information, and the second syntax element information includes picture-level syntax element information and the picture-level syntax element information represents whether the parity hiding technology is enabled at picture-level. The second determining section 20 is further configured to determine the picture-level syntax element information in response to the segment-level variable information indicating that the first preset coding mode is applied to each segment in the current picture.

In some embodiments of the present application, the encoding section 21 is further configured to: determine whether a hidden quantized coefficient exists in the current block in response to the picture-level syntax element information indicating that the parity hiding technology is enabled for the current picture; and encode the absolute value of the quantized coefficient of the current block in response to that a hidden quantized coefficient exists in the current block.

In some embodiments of the present application, the variable information includes segment-level variable information, and the second syntax element information includes segment-level syntax element information and the segment-level syntax element information represents whether the parity hiding technology is enabled at segment-level. The second determining section 20 is further configured to traverse each segment of the current picture, and determining the segment-level syntax element information of a current segment in response to the segment-level variable information indicating that the first preset coding mode is applied to the current segment in the current picture.

In some embodiments of the present application, the encoding section 21 is further configured to: determine whether a hidden quantized coefficient exists in the current block in response to the segment-level syntax element information indicating that the parity hiding technology is enabled for the current segment; and encode the absolute value of the quantized coefficient of the current block in response to that a hidden quantized coefficient exists in the current block.

In some embodiments of the present application, the encoding section 21 is further configured to: determine third syntax element information of the current block based on the second syntax element information, where the third syntax element information represents whether the parity hiding technology is enabled at block-level; determine that a hidden quantized coefficient exists in the current block in response to the third syntax element information indicating that the parity hiding technology is enabled for the current block; and encode the absolute value of the quantized coefficient of the current block in response to that a hidden quantized coefficient exists in the current block.

In some embodiments of the present application, the encoding section 21 is further configured to encode the absolute value of the quantized coefficient of the current block, in response to determining, according to the second syntax element information and at least one of the number of encoded non-zero quantized coefficients, a colour component of the current block, or a transform type of the current block, that a hidden quantized coefficient exists in the current block.

In some embodiments of the present application, the encoding section 21 is further configured to: determine that a hidden quantized coefficient exists in the current block in response to the second syntax element information indicating that the parity hiding technology is enabled and at least one of the following being satisfied: the number of the encoded non-zero quantized coefficients is greater than or equal to a number threshold, the colour component of the current block is a preset component, or the transform type of the current block is a preset transform type; and encode the absolute value of the quantized coefficient of the current block in response to that a hidden quantized coefficient exists in the current block.

In some embodiments of the present application, the encoder 2 further includes: a signalling section 22. The signalling section is configured to signal the first syntax element information and the second syntax element information into a bitstream.

In some embodiments of the present application, the encoder 2 further includes: the signalling section 22. The signalling section is configured to signal the third syntax element information into the bitstream.

In some embodiments of the present application, the first preset coding mode is a lossy coding mode.

In some embodiments of the present application, the first syntax element information represents a sequence-level flag; the second syntax element information represents a picture-level flag or a segment-level flag.

Based on the structure of the encoder 2 and the computer storage medium described above, FIG. 12 illustrates a schematic diagram of a specific hardware structure of the decoder provided in embodiments of the present application. As illustrated in FIG. 12, the encoder may include: a second communication interface 1201, a second memory 1202, and a second processor 1203. The various components are coupled together via a second bus system 1204. It will be appreciated that the second bus system 1204 is used to enable connection and communication among these components. The second bus system 1204 includes a power bus, a control bus, and a status signal bus in addition to a data bus. However, for the sake of clarity of illustration, various buses are designated as the second bus system 1204 in FIG. 12.

The second communication interface 1201 is configured to receive and transmit signals in the process of transmitting and receiving information with other external network elements.

The second memory 1202 is configured to store a computer program capable of running on the second processor 1203.

The second processor 1203 is configured to execute the encoding method implemented by the encoder when the computer program is executed.

It can be understood that, at the encoding end, when it is determined according to the first syntax element information that the parity hiding technology is enabled at sequence-level, whether to generate the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the encoder encodes the absolute value of the quantized coefficient of the current block with the parity hiding technology. Thus, according to the high-level syntax (i.e., the second syntax element information) that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding and decoding, to reduce the bitrate of encoding and improve the efficiency and performance of encoding.

In still another embodiment of the present application, FIG. 13 illustrates a schematic diagram of a structure of a coding system provided in embodiments of the present application. As illustrated in FIG. 13, the coding system 130 may include an encoding device 1301 and a decoding device 1302. The encoding device 1301 may be the encoder according to any one of the above embodiments, and the decoding device 1302 may be the decoder according to any one of the above embodiments.

In embodiments of the present application, the encoding device 1301 and the decoding device 1302 in the coding system 130 may perform information exchange, for example, a bitstream generated by the encoding device 1301 may be transmitted to the decoding device 1302. In this way, for the coding system 130, at the encoding end or the decoding end, when it is determined according to the first syntax element information that the parity hiding technology is enabled at sequence-level, whether to generate the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the encoder encodes the absolute value of the quantized coefficient of the current block with the parity hiding technology. Thus, according to the high-level syntax (i.e., the second syntax element information) that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding and decoding, to reduce the bitrate of encoding and improve the efficiency and performance of encoding.

It should be noted that in the present application, the terms “including” “containing” or any other variation thereof are intended to encompass a non-exclusive inclusion such that a process, method, article, or apparatus including a series of elements includes not only those elements, but also other elements not explicitly listed, or elements inherent to such a process, method, article, or apparatus. Without further limitation, an element defined by the statement “including a” does not preclude the presence of additional identical elements in a process, method, article, or apparatus that includes the element.

The above-described serial numbers of embodiments of the present application are merely for description, and do not represent the advantages and disadvantages of embodiments.

The methods disclosed in several method embodiments provided in the present application can be arbitrarily combined without conflict to obtain new method embodiments.

The features disclosed in several product embodiments provided in the present application can be arbitrarily combined without conflict to obtain new product embodiments.

The features disclosed in several method or device embodiments provided in the present application can be arbitrarily combined without conflict to obtain new method or device embodiments.

The above is merely a specific embodiment of the present application, but the scope of protection of the present application is not limited thereto, and any person skilled in the art can easily think of changes or substitutions within the technical scope disclosed in the present application, and should be covered within the scope of protection of the present application. Therefore, the scope of protection of the present application should be based on the scope of protection of the claims.

### INDUSTRIAL APPLICABILITY

In embodiments of the present application, at the encoding end or the decoding end, when it is determined according to the first syntax element information that the parity hiding technology is enabled at sequence-level, whether to generate the second syntax element information is determined according to the variable information and the first preset coding mode (lossy coding), where the second syntax element information indicates whether the parity hiding technology is enabled at picture-level or the segment-level. In this way, when using the parity hiding technology, in the case of adopting the first preset coding mode, by determining the second syntax element information, the encoder encodes the absolute value of the quantized coefficient of the current block with the parity hiding technology. Thus, according to the high-level syntax (i.e., the second syntax element information) that depends on whether lossy coding (or conversely understood as lossless coding) is adopted, the encoding process using the parity hiding technology can be controlled effectively. Therefore, in the process of encoding, the applicability of using the parity hiding technology can be improved, and with the better applicability of the parity hiding technology, the parity hiding technology is applied to the process of encoding and decoding, to reduce the bitrate of encoding and improve the efficiency and performance of encoding.

What is claimed is:

1. A decoding method, performed by a decoder and comprising:
parsing a bitstream to determine first syntax element information;
obtaining variable information in response to the first syntax element information indicating that a parity hiding technology is enabled for a sequence;
determining second syntax element information in response to the variable information indicating that a segment satisfying a first preset coding mode exists in a current picture; and
determining an absolute value of a quantized coefficient of a current block, in response to determining, based on the second syntax element information, that a hidden quantized coefficient exists in the current block.

2. The method of claim 1, wherein the variable information comprises picture-level variable information, and the second syntax element information comprises picture-level syntax element information and the picture-level syntax element information represents whether the parity hiding technology is enabled at picture-level;
determining the second syntax element information in response to the variable information indicating that a segment satisfying the first preset coding mode exists in the current picture comprising:
determining the picture-level syntax element information in response to the picture-level variable information indicating that at least one segment applying the first preset coding mode exists in the current picture.

3. The method of claim 2, wherein determining the absolute value of the quantized coefficient of the current block, in response to determining, based on the second syntax element information, that a hidden quantized coefficient exists in the current block comprises:
determining whether a hidden quantized coefficient exists in the current block in response to the picture-level syntax element information indicating that the parity hiding technology is enabled for the current picture and the first preset coding mode is applied to a current segment containing the current block; and
determining the absolute value of the quantized coefficient of the current block in response to that a hidden quantized coefficient exists in the current block.

4. The method of claim 1, wherein the variable information comprises segment-level variable information, and the second syntax element information comprises picture-level syntax element information and the picture-level syntax element information represents whether the parity hiding technology is enabled at picture-level;
determining the second syntax element information in response to the variable information indicating that a segment satisfying the first preset coding mode exists in the current picture comprising:
determining the picture-level syntax element information in response to the segment-level variable information indicating that the first preset coding mode is applied to each segment in the current picture.

5. The method of claim 4, wherein determining the absolute value of the quantized coefficient of the current block, in response to determining, based on the second syntax element information, that a hidden quantized coefficient exists in the current block comprises:
determining whether a hidden quantized coefficient exists in the current block in response to the picture-level syntax element information indicating that the parity hiding technology is enabled for the current picture; and
determining the absolute value of the quantized coefficient of the current block in response to that a hidden quantized coefficient exists in the current block.

6. The method of claim 1, wherein the variable information comprises segment-level variable information, and the second syntax element information comprises segment-level syntax element information and the segment-level syntax element information represents whether the parity hiding technology is enabled at segment-level;
determining the second syntax element information in response to the variable information indicating that a segment satisfying the first preset coding mode exists in the current picture comprising:
traversing each segment of the current picture, and determining the segment-level syntax element information of a current segment in response to the segment-level variable information indicating that the first preset coding mode is applied to the current segment in the current picture.

7. The method of claim 6, wherein determining the absolute value of the quantized coefficient of the current block, in response to determining, based on the second syntax element information, that a hidden quantized coefficient exists in the current block comprises:
determining whether a hidden quantized coefficient exists in the current block in response to the segment-level syntax element information indicating that the parity hiding technology is enabled for the current segment; and
determining the absolute value of the quantized coefficient of the current block in response to that a hidden quantized coefficient exists in the current block.

8. The method of claim 1, wherein determining the absolute value of the quantized coefficient of the current block, in response to determining, based on the second syntax element information, that a hidden quantized coefficient exists in the current block comprises:
determining the absolute value of the quantized coefficient of the current block, in response to determining, according to the second syntax element information and at least one of the number of decoded non-zero quantized coefficients, a colour component of the current block, or a transform type of the current block, that a hidden quantized coefficient exists in the current block.

9. The method of claim 8, wherein determining the absolute value of the quantized coefficient of the current block, in response to determining, according to the second syntax element information and at least one of the number of the decoded non-zero quantized coefficients, the colour component of the current block, or the transform type of the current block, that a hidden quantized coefficient exists in the current block comprises:
determining that a hidden quantized coefficient exists in the current block in response to the second syntax element information indicating that the parity hiding technology is enabled and at least one of the following being satisfied: the number of the decoded non-zero quantized coefficients is greater than or equal to a number threshold, the colour component of the current block is a preset component, or the transform type of the current block is a preset transform type; and
determining the absolute value of the quantized coefficient of the current block in response to that a hidden quantized coefficient exists in the current block.

10. The method of claim 1, wherein the first preset coding mode is a lossy coding mode.

11. The method of claim 1, wherein:
the first syntax element information represents a sequence-level flag; and
the second syntax element information represents a picture-level flag or a segment-level flag.

12. An encoding method, performed by an encoder and comprising:
determining first syntax element information;
obtaining variable information in response to the first syntax element information indicating that a parity hiding technology is enabled for a sequence;
determining second syntax element information in response to the variable information indicating that a segment satisfying a first preset coding mode exists in a current picture; and
encoding an absolute value of a quantized coefficient of a current block based on the second syntax element information.

13. The method of claim 12, wherein the variable information comprises picture-level variable information, and the second syntax element information comprises picture-level syntax element information and the picture-level syntax element information represents whether the parity hiding technology is enabled at picture-level;
determining the second syntax element information in response to the variable information indicating that a segment satisfying the first preset coding mode exists in the current picture comprising:
determining the picture-level syntax element information in response to the picture-level variable information indicating that at least one segment applying the first preset coding mode exists in the current picture.

14. The method of claim 13, wherein encoding the absolute value of the quantized coefficient of the current block based on the second syntax element information comprises:
determining whether a hidden quantized coefficient exists in the current block in response to the picture-level syntax element information indicating that the parity hiding technology is enabled for the current picture and the first preset coding mode is applied to a current segment containing the current block; and
encoding the absolute value of the quantized coefficient of the current block in response to that a hidden quantized coefficient exists in the current block.

15. The method of claim 12, wherein the variable information comprises segment-level variable information, and the second syntax element information comprises picture-level syntax element information and the picture-level syntax element information represents whether the parity hiding technology is enabled at picture-level;
determining the second syntax element information in response to the variable information indicating that a segment satisfying the first preset coding mode exists in the current picture comprising:
determining the picture-level syntax element information in response to the segment-level variable information indicating that the first preset coding mode is applied to each segment in the current picture.

16. The method of claim 15, wherein encoding the absolute value of the quantized coefficient of the current block based on the second syntax element information comprises:
determining whether a hidden quantized coefficient exists in the current block in response to the picture-level syntax element information indicating that the parity hiding technology is enabled for the current picture; and
encoding the absolute value of the quantized coefficient of the current block in response to that a hidden quantized coefficient exists in the current block.

17. The method of claim 12, wherein the variable information comprises segment-level variable information, and the second syntax element information comprises segment-level syntax element information and the segment-level syntax element information represents whether the parity hiding technology is enabled at segment-level;
determining the second syntax element information in response to the variable information indicating that a segment satisfying the first preset coding mode exists in the current picture comprising:
traversing each segment of the current picture, and determining the segment-level syntax element information of a current segment in response to the segment-level variable information indicating that the first preset coding mode is applied to the current segment in the current picture.

18. The method of claim 17, wherein encoding the absolute value of the quantized coefficient of the current block based on the second syntax element information comprises:
determining whether a hidden quantized coefficient exists in the current block in response to the segment-level syntax element information indicating that the parity hiding technology is enabled for the current segment; and
encoding the absolute value of the quantized coefficient of the current block in response to that a hidden quantized coefficient exists in the current block.

19. The method of claim 12, wherein encoding the absolute value of the quantized coefficient of the current block based on the second syntax element information comprises:
determining that a hidden quantized coefficient exists in the current block in response to the second syntax element information indicating that the parity hiding technology is enabled and at least one of the following being satisfied: the number of encoded non-zero quantized coefficients is greater than or equal to a number threshold, a colour component of the current block is a preset component, or a transform type of the current block is a preset transform type; and
encoding the absolute value of the quantized coefficient of the current block in response to that a hidden quantized coefficient exists in the current block.

20. A method of transmitting a bitstream, comprising one of the following:
decoding the bitstream by:
parsing the bitstream to determine first syntax element information;
obtaining variable information in response to the first syntax element information indicating that a parity hiding technology is enabled for a sequence;
determining second syntax element information in response to the variable information indicating that a segment satisfying a first preset coding mode exists in a current picture; and
determining an absolute value of a quantized coefficient of a current block, in response to determining, based on the second syntax element information, that a hidden quantized coefficient exists in the current block; or
generating the bitstream by:
determining the first syntax element information;
obtaining the variable information in response to the first syntax element information indicating that the parity hiding technology is enabled for the sequence;
determining the second syntax element information in response to the variable information indicating that a segment satisfying the first preset coding mode exists in the current picture; and
encoding the absolute value of the quantized coefficient of the current block based on the second syntax element information.
